(19) United States
(12) Patent Application Publication
(10) Pub. No.: US 2013/0285937 A1
(43) Pub. Date: Oct. 31, 2013

(54) CONNECTED MULTI-SCREEN VIDEO MANAGEMENT

(71) Applicants: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(72) Inventors: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(73) Assignee: MobiTV, Inc, Emeryville, CA (US)

(21) Appl. No.: 13/587,451

(22) Filed: Aug. 16, 2012

Related U.S. Application Data
(60) Provisional application No. 61/639,689, filed on Apr. 27, 2012.

(51) Int. Cl. G06F 15/00; G06F 3/041

(52) U.S. Cl. 345/173; 345/501

(57) ABSTRACT

Disclosed herein are techniques and mechanisms for connected multi-screen video management. According to various embodiments, content management information may be received from a remote server. The received content management information may be stored on a storage medium. The received content management information may be processed to provide a content management interface. The content management interface may include a plurality of media content categories. Each of the media content categories may include a plurality of media content items available for presentation at the computing device. Each of the media content items may be retrievable from a respective media content source. At least two of the media content items may be retrievable from different media content sources. The content management interface may be displayed on a display screen.

### CROSS-REFERENCE TO RELATED APPLICATIONS

This application claims priority to Provisional U.S. Patent Application No. 61/639,689 by Billings et al., filed Apr. 27, 2012, titled “CONNECTED MULTI-SCREEN VIDEO”, which is hereby incorporated by reference in its entirety and for all purposes.

### TECHNICAL FIELD

The present disclosure relates to connected multi-screen video.

### DESCRIPTION OF RELATED ART

A variety of devices in different classes are capable of receiving and playing video content. These devices include tablets, smartphones, computer systems, game consoles, smart televisions, and other devices. The diversity of devices combined with the vast amounts of available media content have created a number of different presentation mechanisms.

However, mechanisms for providing common experiences across different device types and content types are limited. Consequently, the techniques of the present invention provide mechanisms that allow users to have improved experiences across devices and content types.

### BRIEF DESCRIPTION OF THE DRAWINGS

The disclosure may best be understood by reference to the following description taken in conjunction with the accompanying drawings, which illustrate particular embodiments.

FIGS. 1 and 2 illustrate examples of systems that can be used with various techniques and mechanisms of the present invention.

FIGS. 3-15 illustrate images of examples of user interfaces.

FIGS. 16-18 illustrate examples of techniques for communicating between various devices.

FIG. 19 illustrates a diagram of an example asset entity structure.

FIGS. 20-32 illustrate images of examples of user interfaces.

FIG. 33 illustrates one example of a system.

FIG. 34 illustrates an example of a media delivery system.

FIG. 35 illustrates examples of encoding streams.

FIG. 36 illustrates one example of an exchange used with a media delivery system.

FIG. 37 illustrates one technique for generating a media segment.

FIG. 38 illustrates one example of a system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Disclosed herein are mechanisms and techniques that may be used to provide a connected, multi-screen user interface. Users may employ various types of devices to view media content such as video and audio. The devices may be used alone or together to present the media content. The media content may be received at the devices from various sources. According to various embodiments, different devices may communicate to present a common interface across the devices.

### Example Embodiments

According to various embodiments, a connected multi-screen system may provide a common experience across devices while allowing multi-screen interactions and navigation. Content may be organized around content entities such as shows, episodes, sports categories, genres, etc. The system includes an integrated and personalized guide along with effective search and content discovery mechanisms. Co-watching and companion information is provided to allow for social interactivity and metadata exploration.

According to various embodiments, a connected multi-screen interface is provided to allow for a common experience across devices in a way that is optimized for various device strengths. Media content is organized around media entities such as shows, programs, episodes, characters, genres, categories, etc. In particular embodiments, live television, on-demand, and personalized programming are presented together. Multi-screen interactions and navigation are provided with social interactivity, metadata exploration, show information, and reviews.

According to various embodiments, a connected multi-screen interface may be provided on two or more display screens associated with different devices. The connected interface may provide a user experience that is focused on user behaviors, not on a particular device or service. In particular embodiments, a user may employ different devices for different media-related tasks. For instance, a user may employ a television to watch a movie while using a connected tablet computer to search for additional content or browse information related to the movie.

According to various embodiments, a connected interface may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

According to various embodiments, a media content data structure may be created to provide structure and organization to media content. The media content data structure may include media content assets and media content entities. A media content asset may be any media content item that may be presented to a user via a media presentation device. For example, a media content asset may be a television episode, movie, song, audio book, radio program, or any other video and/or audio content. A media content entity may be any category, classification, or container that imposes structure on the media content assets. In particular embodiments, a media content entity may include media content assets and other media content entities. For example, a media content entity may correspond to a television program, a particular season of a television program, a content genre such as “dramas”, a series of movies, a director or cast member, or any other category or classification.

In a specific example, a media content entity may correspond to the television program Dexter. This media content entity may contain as members other media content entities corresponding to the different seasons of Dexter. In turn, each of these media content entities may contain as members media content assets corresponding to the different episodes of Dexter within each season.

According to various embodiments, the media content data structure may drive a user interface. For instance, a user interface may display information regarding a particular media content entity or entities. The information may designate media content assets or other media content entities that are members of the displayed media content entity. In particular embodiments, the user interface may be displayed as part of a connected user interface that may be presented across two or more devices, as described herein.

According to various embodiments, a media content data structure and an accompanying user interface may be used to present various types of information regarding relationships between content. For example, a media content data structure and an accompanying user interface may be used to present information regarding the next unwatched episode or movie in a series. As another example, a media content data structure and an accompanying user interface may be used to present information regarding content having similar subject matter, a common cast or crew member, or from a similar classification or genre.

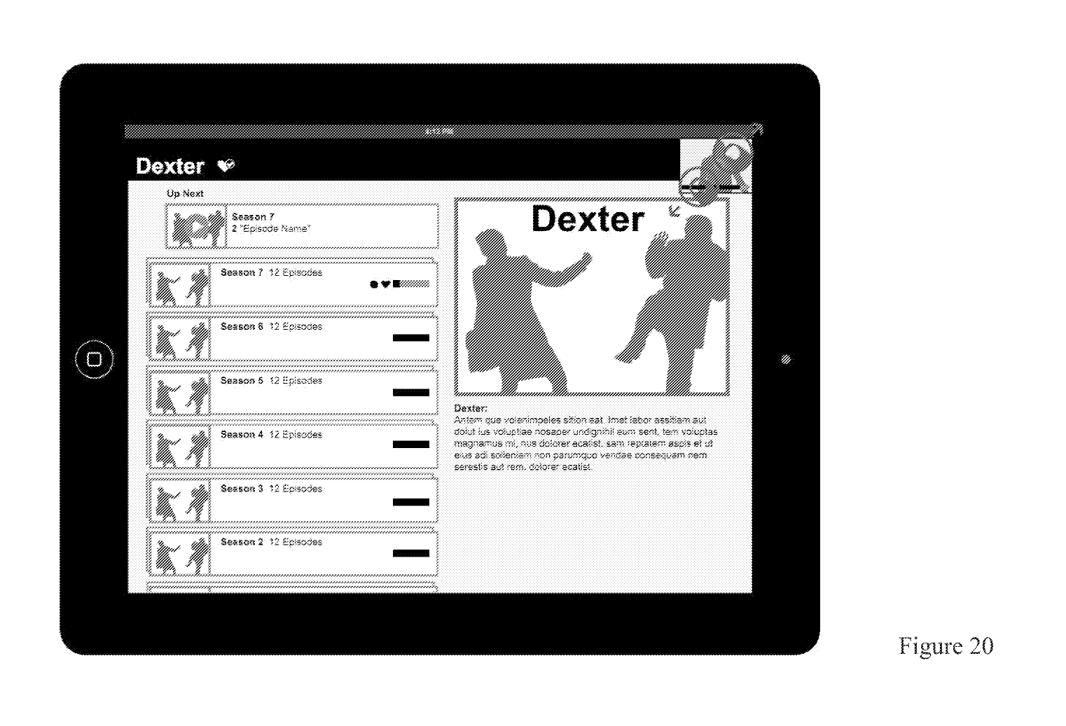

According to various embodiments, media content entities may be used to provide structure and organization to different types of content. Because media content entities are flexible containers, different types of content may be organized with different media content structures. For instance, different media content structures may be created for television programs, sports, movies, music, and other types of content. Examples of the different types of structures that may be created are discussed in additional detail with respect to FIGS. 20-32.

According to various embodiments, a media content data structure may be used to organize media content that may be received from various sources. For instance, a user may receive media content via cable television, a paid internet content provider such as Netflix, a free internet content provider such as YouTube, a local library of purchased content, and a paid per-content download service such as iTunes. By organizing this content within a data structure, a user may be able to navigate, search, filter, and browse the content together rather than separately performing these functions for each available content source.

According to various embodiments, a media content data structure and an accompanying user interface may be used to present various types of information regarding the accessibility of content. For example, when a user has access to a subscription-based media content provider such as Netflix, content available from the content provider may be included in the data structure and user interface. In this way, a user may be made aware of content already available to the user. As another example, when content is available on a paid basis, such as via a content provider such as iTunes or Amazon, the content may be included within the data structure and user interface. In this way, a user may be made aware of content that the user does not yet have access to. In particular embodiments, a user may be able to designated options specifying the types and sources of content to include in the data structure and user interface.

According to various embodiments, a media content data structure may be used to organize media content that may be presented on different media content presentation devices. For example, a user may receive content via a cable television service subscription at a television. At the same time, the user may receive content via a Netflix service subscription at a computer. By combining this content into a single data structure, the user may be able to navigate, search, filter, and browse the content regardless of the device on which the content is presented.

According to various embodiments, media content entities may be used to create categories for identifying content corresponding to user preferences. For instance, the content management system may collect data indicating that a particular user enjoys watching dramas. Then, the content management system may receive more detailed information indicating a preference for television dramas in particular. When a user accesses the content management system, the user may be presented with media content entities reflecting these observed preferences. For instance, an electronic program guide may include a customized channel that includes an entity or entities corresponding to a user preference.

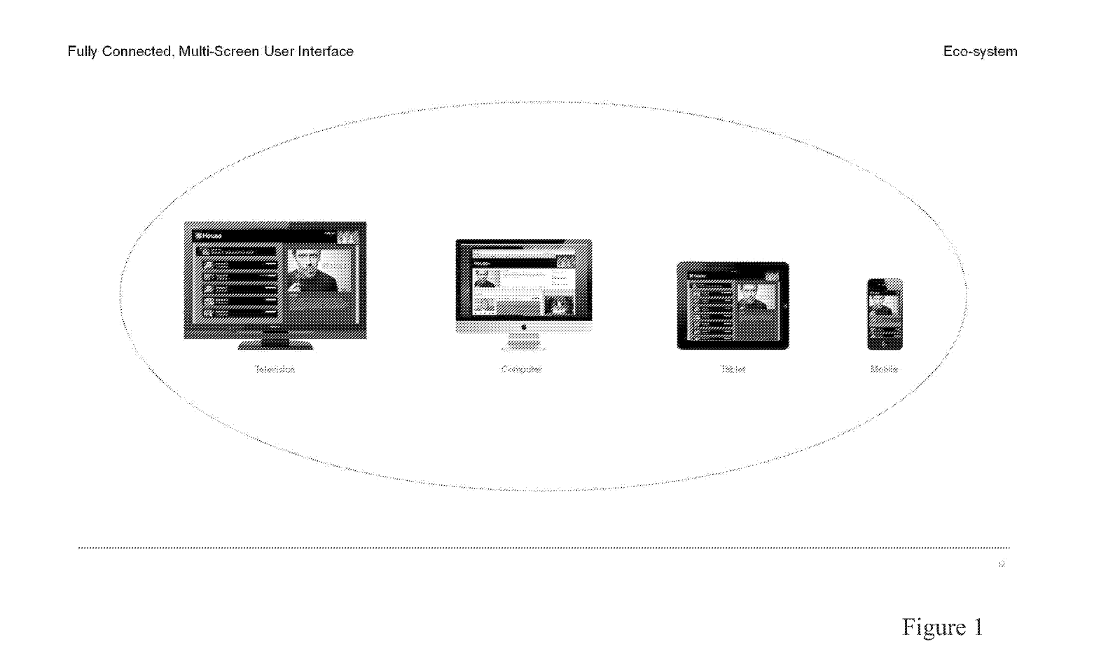

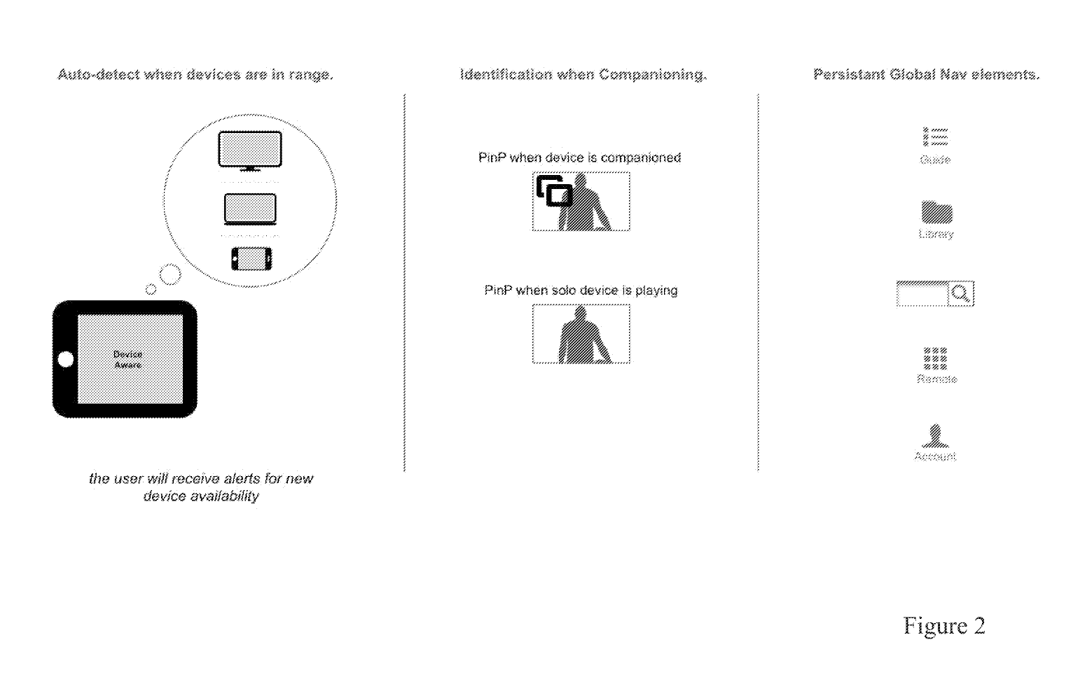

FIGS. 1 and 2 illustrate examples of systems that can be used with various techniques and mechanisms of the present invention. As shown in FIG. 1, various devices may be used to view a user interface for presenting and/or interacting with content. According to various embodiments, one or more conventional televisions, smart televisions, desktop computers, laptop computers, tablet computers, or mobile devices such as smart phones may be used to view a content-related user interface.

According to various embodiments, a user interface for presenting and/or interacting with media content may include various types of components. For instance, a user interface may include one or more media content display portions, user interface navigation portions, media content guide portions, related media content portions, media content overlay portions, web content portions, interactive application portions, or social media portions.

According to various embodiments, the media content displayed on the different devices may be of various types and/or derive from various sources. For example, media content may be received from a local storage location, a network storage location, a cable or satellite television provider, an Internet content provider, or any other source. The media content may include audio and/or video and may be television, movies, music, online videos, social media content, or any other content capable of being accessed via a digital device.

As shown in FIG. 2, devices may communicate with each other. According to various embodiments, devices may communicate directly or through another device such as a network gateway or a remote server. In some instances, communications may be initiated automatically. For example, an active device that comes within range of another device that may be used in conjunction with techniques described herein may provide an alert message or other indication of the possibility of a new connection. As another example, an active device may automatically connect with a new device within range.

According to various embodiments, a user interface may include one or more portions that are positioned on top of another portion of the user interface. Such a portion may be referred to herein as a picture in picture, a PinP, an overlaid portion, an asset overlay, or an overlay.

According to various embodiments, a user interface may include one or more navigation elements, which may include, but are not limited to media content guide element, a library element, a search element, a remote control element, and an account access element. These elements may be used to access various features associated with the user interface, such as a search feature or media content guide feature.

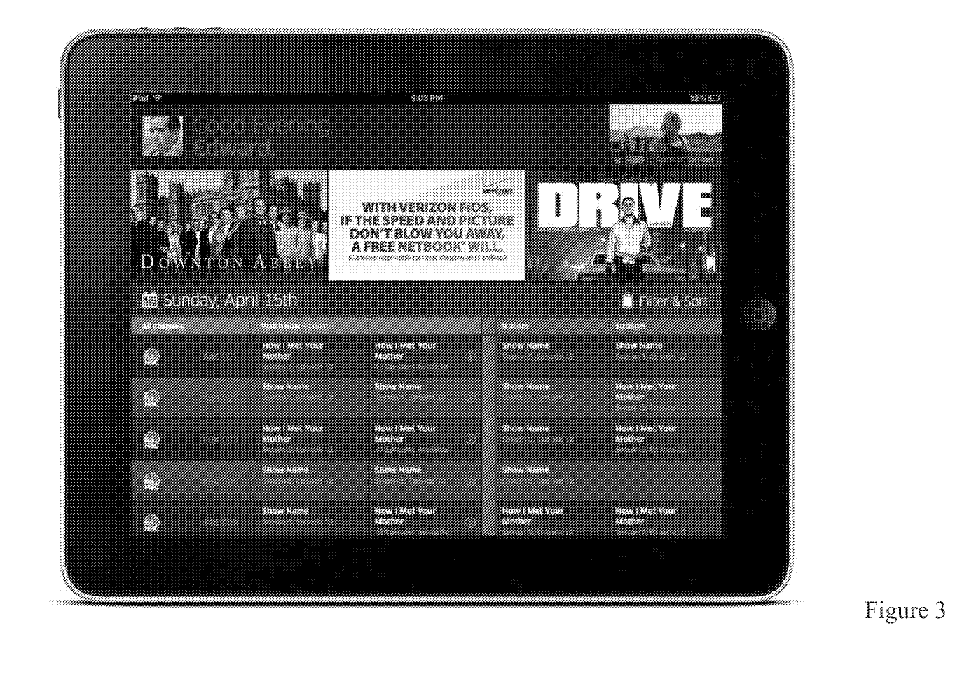

FIGS. 3-15 illustrate images of examples of user interfaces. According to various embodiments, the user interfaces shown may be presented on any of various devices. In some cases, user interfaces may appear somewhat differently on different devices. For example, different devices may have different screen display resolutions, screen display aspect ratios, and user input device capabilities. Accordingly, a user interface may be adapted to a particular type of device.

FIG. 3 illustrates an image of an example of a program guide user interface. According to various embodiments, a program guide user interface may be used to identify media content items for presentation. The program guide may include information such as a content title, a content source, a presentation time, an example video feed, and other information for each media content item. The program guide may also include other information, such as advertisements and filtering and sorting elements.

According to various embodiments, the techniques and mechanisms described herein may be used in conjunction with grid-based electronic program guides. In many grid-based electronic program guides, content is organized into “channels” that appear on one dimension of the grid and time that appears on the other dimension of the grid. In this way, the user can identify the content presented on each channel during a range of time.

According to various embodiments, the techniques and mechanisms described herein may be used in conjunction with mosaic programming guides. In mosaic programming guides, a display includes panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

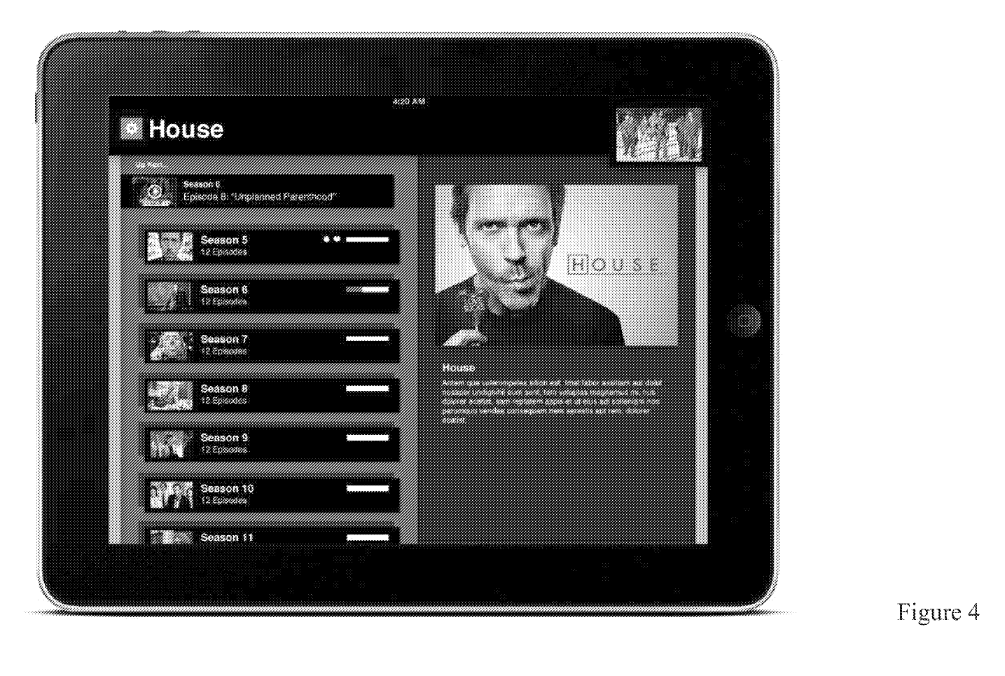

FIG. 4 illustrates an image of an example of a user interface for accessing media content items. According to various embodiments, a media content item may be a media content entity or a media content asset. A media content asset may be any discrete item of media content capable of being presented on a device. A media content entity may be any category, classification, container, or other data object capable of containing one or more media content assets or other media content entities. For instance, in FIG. 4, the television show “House” is a media content entity, while an individual episode of the television show “House” is a media content asset.

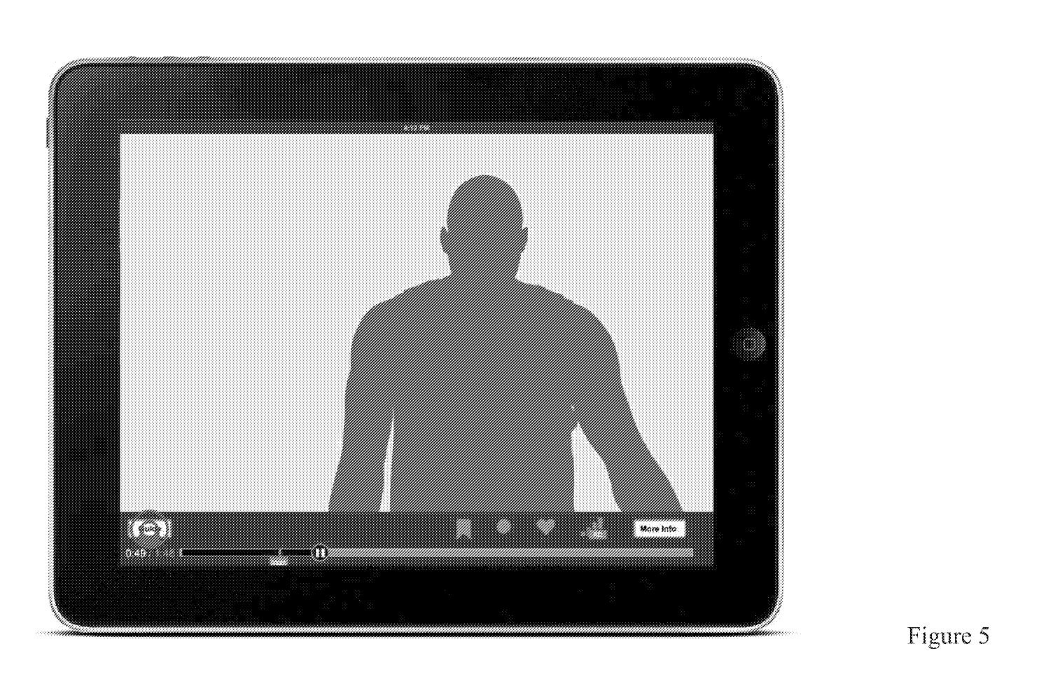

FIG. 5 illustrates an image of an example of a media content playback user interface. According to various embodiments, a media content playback user interface may facilitate the presentation of a media content item. The media content playback user interface may include features such as one or more media content playback controls, media content display areas, and media content playback information portions.

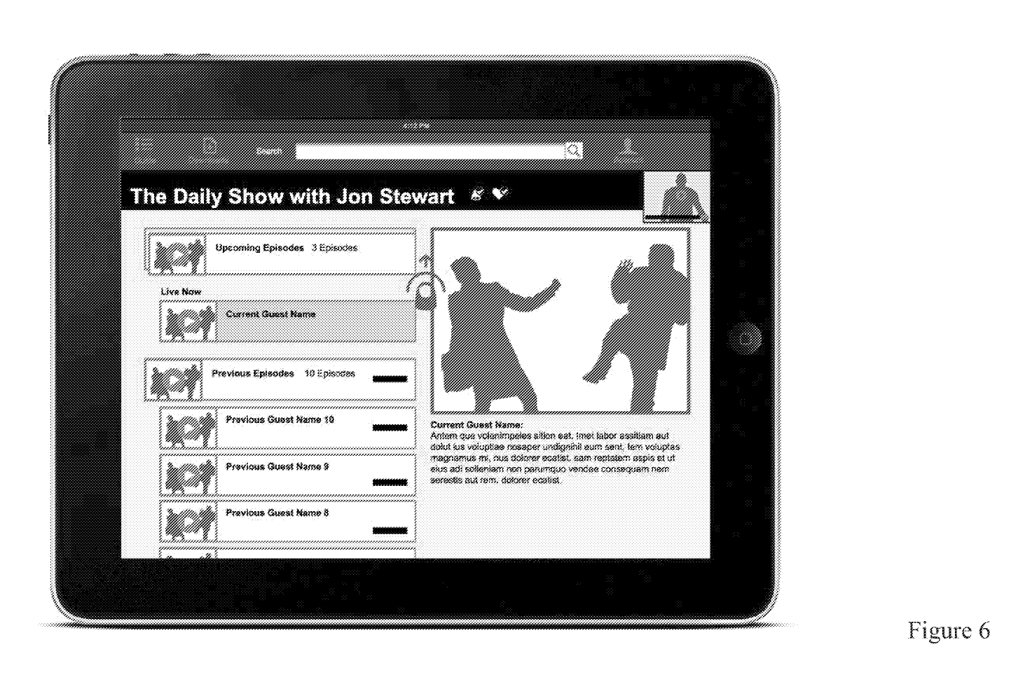

FIG. 6 illustrates an example of a global navigation user interface. According to various embodiments, the global navigation user interface may be used to display information related to a media content item. For instance, the example shown in FIG. 6 includes information related to the media content entity “The Daily Show with Jon Stewart.” In this case, the related information includes links or descriptions of previous and upcoming episodes as well as previous, current, and upcoming guest names. However, a global navigation user guide may display various types of related information, such as cast member biographies, related content, and content ratings. As with many other user interfaces described herein, the global navigation user guide may include an asset overlay for presenting a media clip, which in the example shown in FIG. 6 is displayed in the upper right corner of the display screen. The asset overlay may display content such as a currently playing video feed, which may also be presented on another device such as a television.

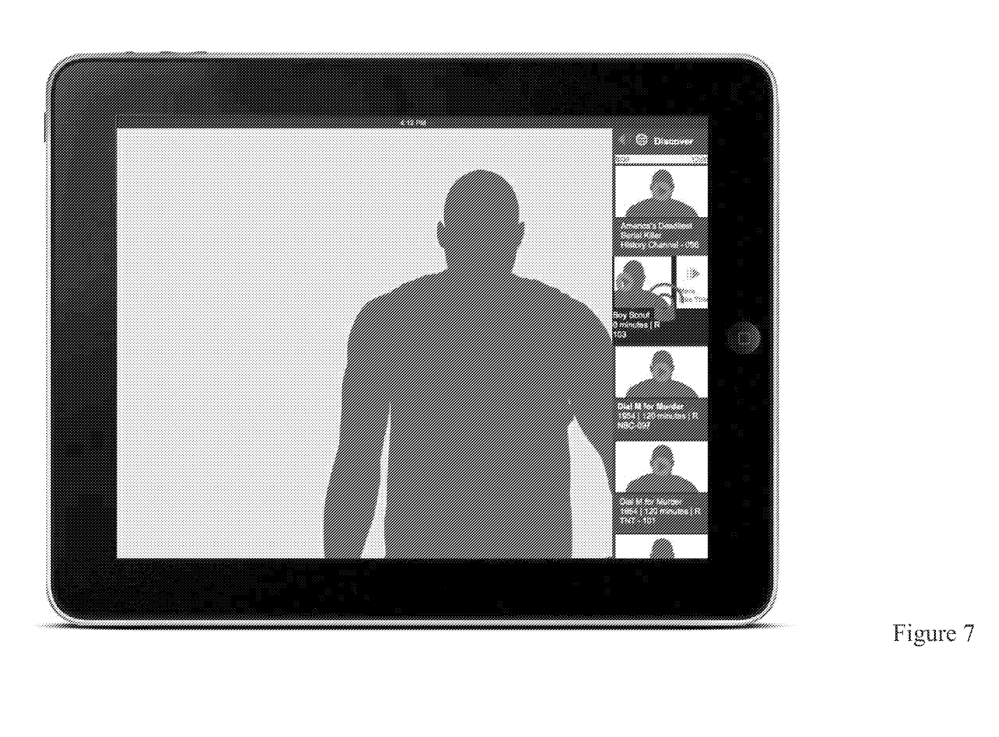

FIG. 7 illustrates an example of a discovery panel user interface within an overlay that appears in front of a currently playing video. According to various embodiments, the discovery panel user interface may include suggestions for other content. For instance, the discovery panel user interface may include information regarding content suggested based on an assumed preference for the content currently being presented. If a television program is being shown, the discovery panel may include information such as movies or other television programs directed to similar topics, movies or television programs that share cast members with the television program being shown, and movies or television programs that often reflect similar preferences to the television program being shown.

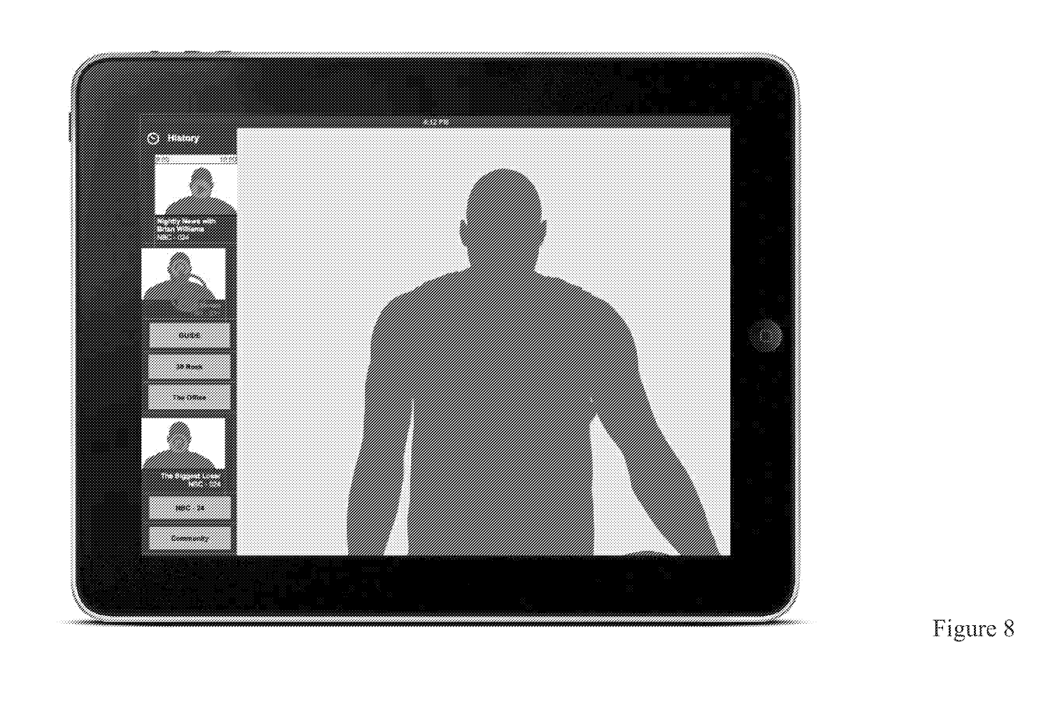

FIG. 8 illustrates an example of a history panel user interface within an overlay that appears in front of a currently playing video. According to various embodiments, the history panel user interface may include information regarding media content items that have been presented in the past. The history panel user interface may display various information regarding such media content items, such as thumbnail images, titles, descriptions, or categories for recently viewed content items.

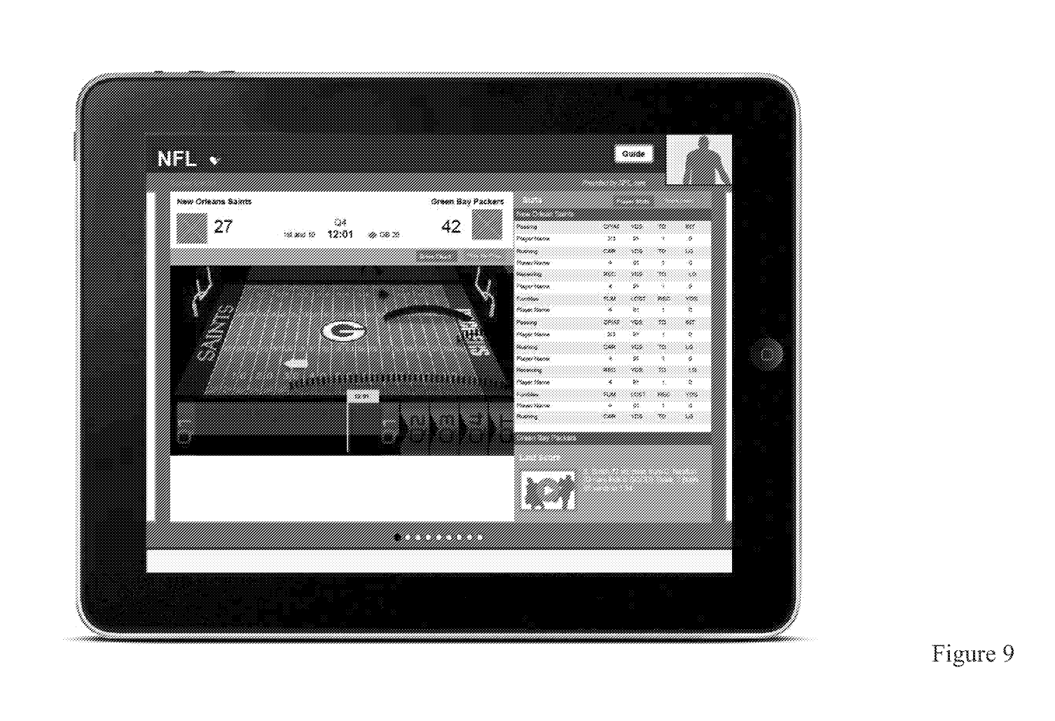

FIG. 9 illustrates an example of an asset overlay user interface configured for companion or co-watching. According to various embodiments, an asset overlay user interface may display information related to content being presented. For example, a user may be watching a football game on a television. At the same time, the user may be viewing related information on a tablet computer such as statistics regarding the players, the score of the game, the time remaining in the game, and the teams' game playing schedules. The asset overlay user interface that presents a smaller scale version of the content being presented on the other device.

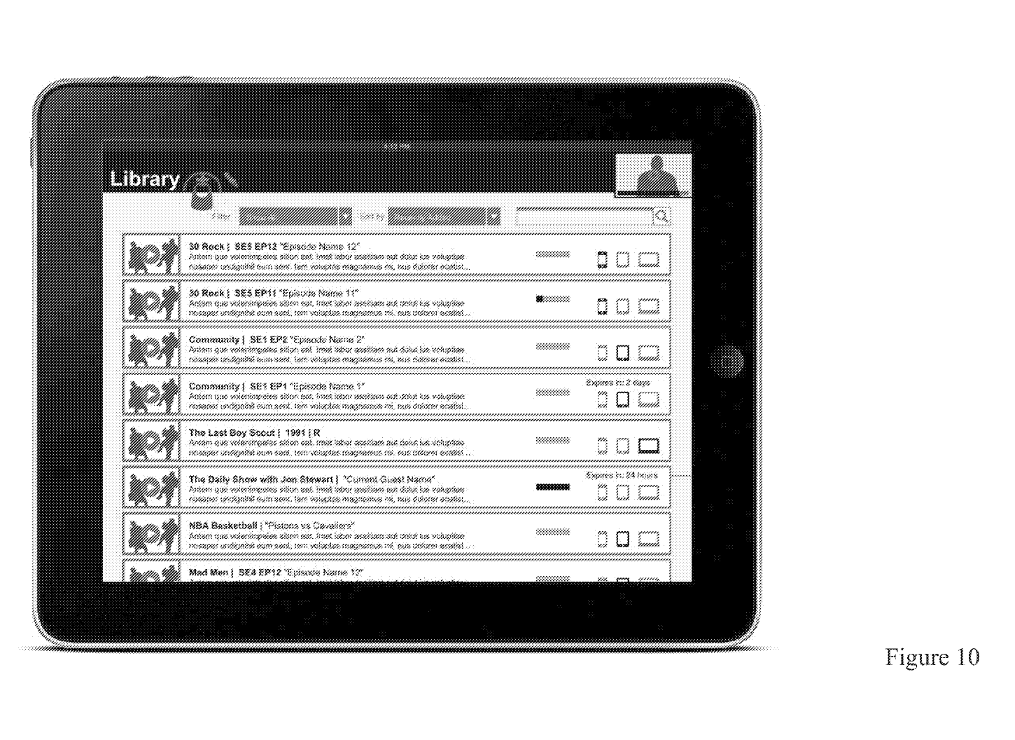

FIG. 10 illustrates an image of an example of a library user interface. According to various embodiments, the library user interface may be used to browse media content items purchased, downloaded, stored, flagged, or otherwise acquired for playback in association with a user account. The library user interface may include features such as one or more media content item lists, media content item list navigation elements, media content item filtering, sorting, or searching elements. The library user interface may display information such as a description, categorization, or association for each media content item. The library user interface may also indicate a device on which the media content item is stored or may be accessed.

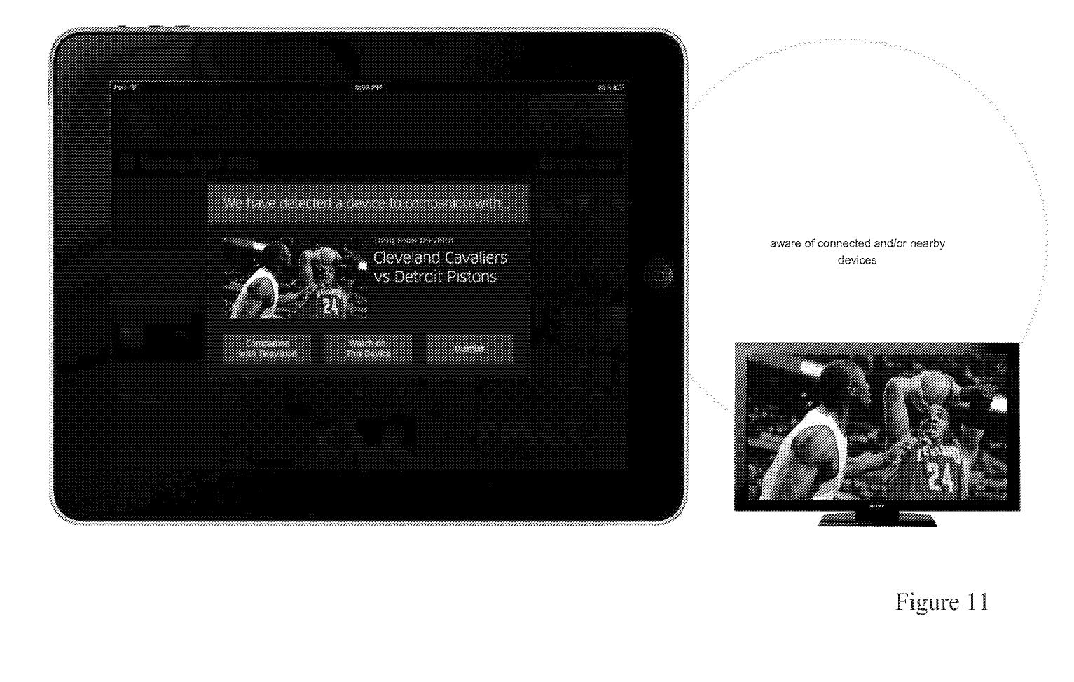

FIGS. 11-15 illustrate images of examples of a connected user interface displayed across two devices. In FIG. 11, a sports program is presented on a television while a content guide is displayed on a tablet computer. Because the television is capable of connecting with the tablet computer, the tablet computer presents an alert message that informs the user of the possibility of connecting. Further, the alert message allows the user to select an option such as watching the television program on the tablet computer, companioning with the television to view related information on the tablet computer, or dismissing the connection.

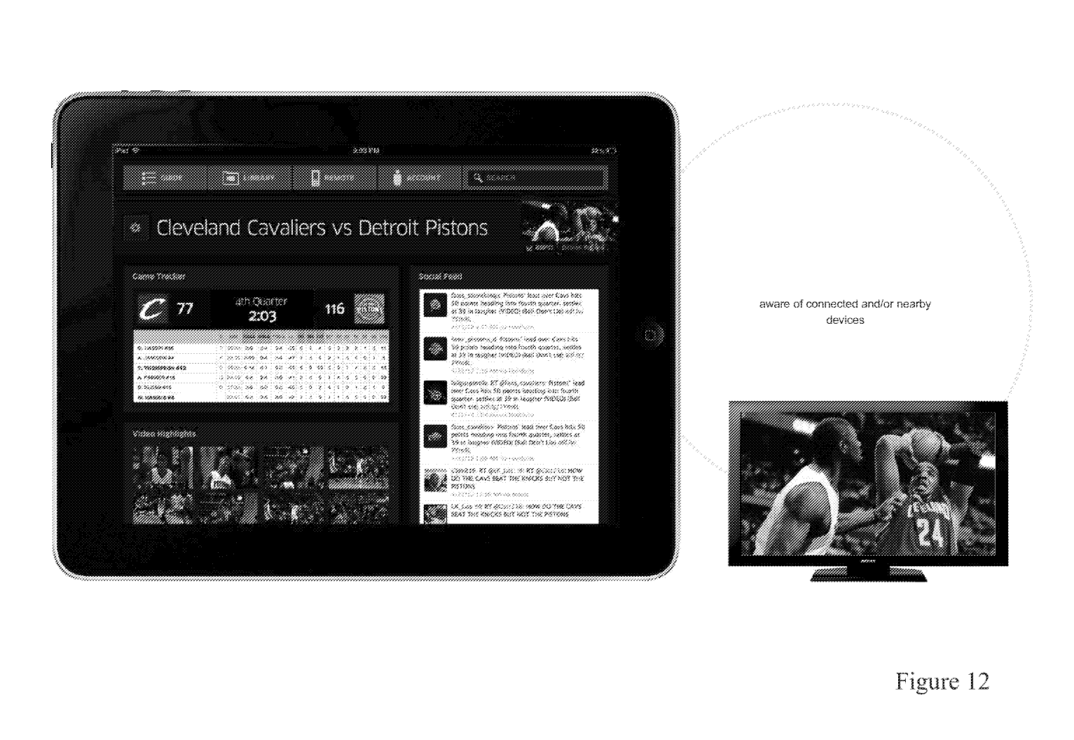

In FIG. 12, the tablet computer is configured for companion viewing. In companion viewing mode, the tablet computer may display information related to the content displayed on the television. For instance, in FIG. 12, the tablet computer is displaying the score of the basketball game, social media commentary related to the basketball game, video highlights from the game, and play statistics. In addition, the tablet computer displays a smaller, thumbnail image sized video of the content displayed on the television.

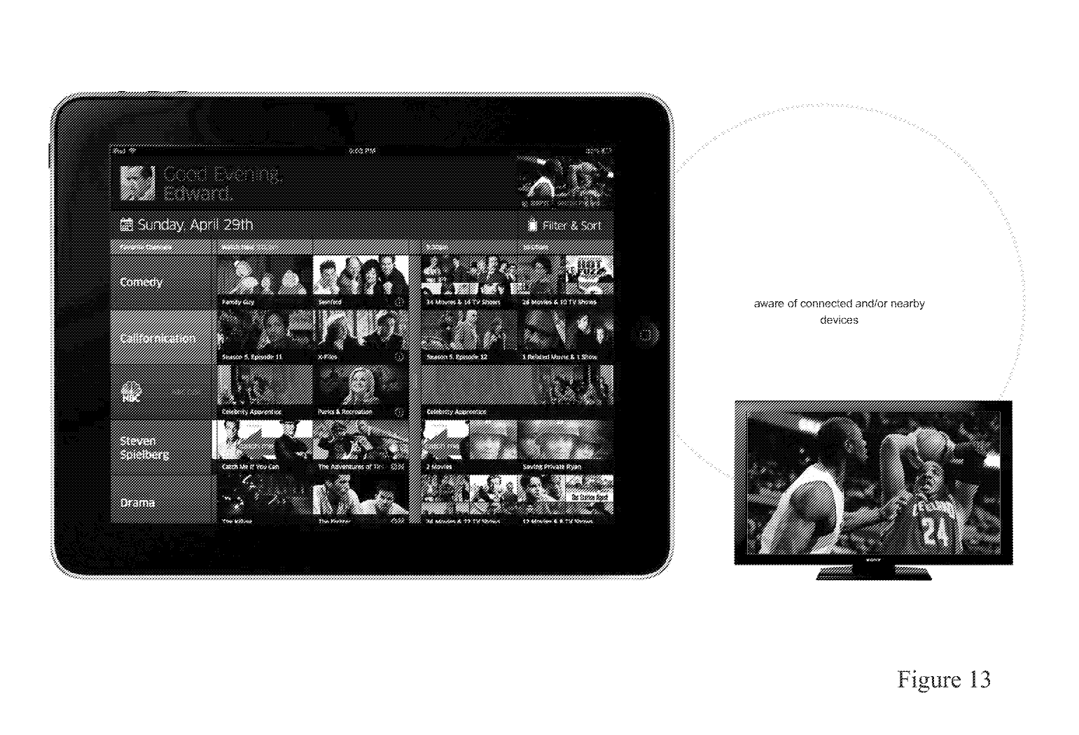

In FIG. 13, the user browses for new content while continuing to view the basketball game in companion mode across the two devices. Accordingly, the tablet computer displays a content guide for selecting other content while continuing to display the smaller, thumbnail image sized video of the basketball game displayed on the television.

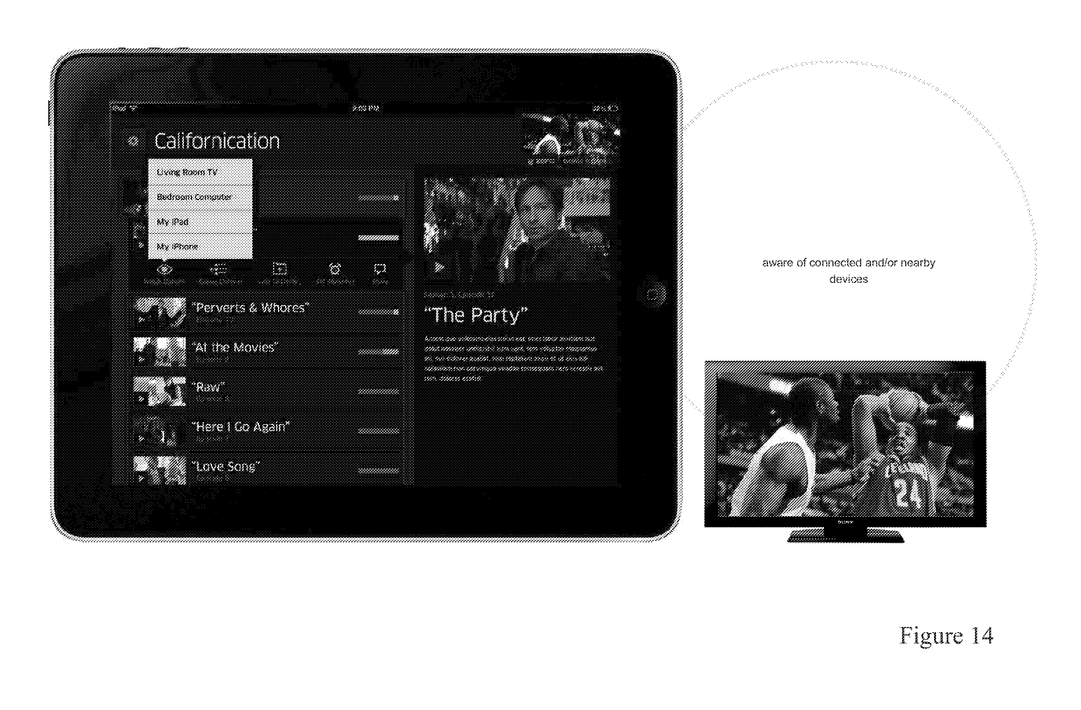

In FIG. 14, the user is in the process of selecting a new media content item for display. Here the new media content item is a television episode called “The Party.” After selecting the media content item, the user may select a device for presenting the content. In FIG. 14, the available devices for selection include the Living Room TV, the Bedroom Computer, My iPad, and My iPhone. By allowing control of content across different devices, the connected user interface can provide a seamless media viewing experience.

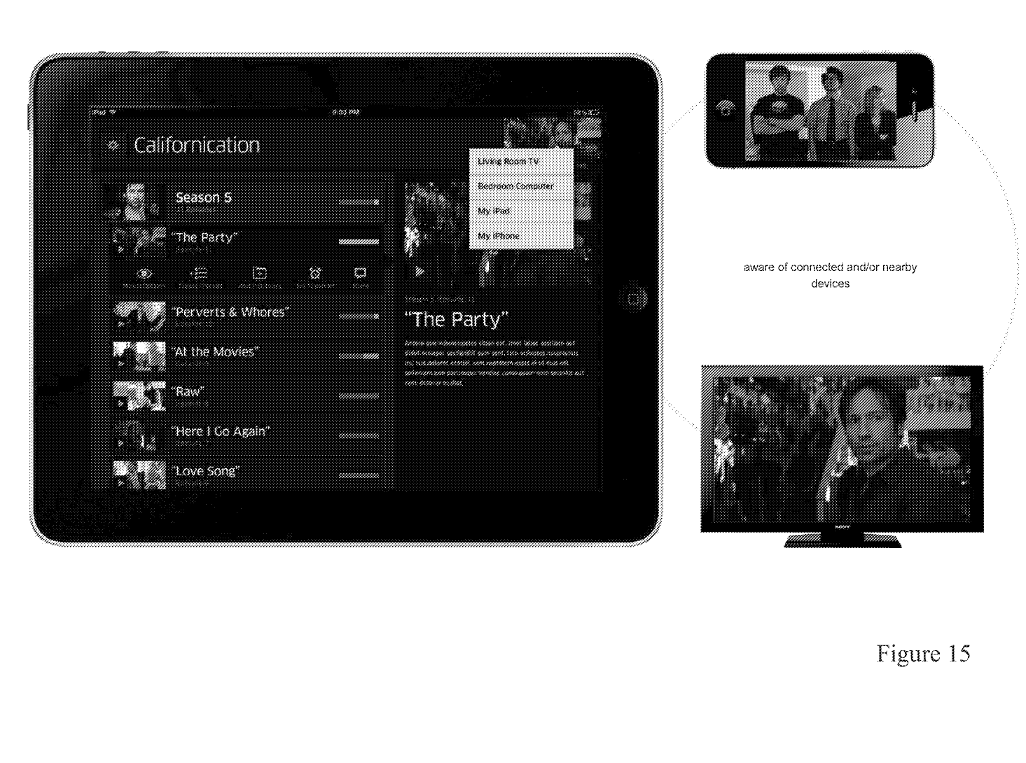

In FIG. 15, the user has selected to view the new television program on the Living Room TV. Additionally, a new device, which is a mobile phone, has entered the set of connected and/or nearby devices. By selecting the device within the user interface, the user can cause the currently playing video to also display on the mobile phone. In this way, the user can continue a video experience without interruption even if the user moves to a different physical location. For example, a user may be watching a television program on a television while viewing related information on a tablet computer. When the user wishes to leave the house, the user may cause the television program to also display on a mobile phone, which allows the user to continue viewing the program.

It should be noted that the user interfaces shown in FIGS. 3-15 are only examples of user interfaces that may be presented in accordance with techniques and mechanisms described herein. According to various embodiments, user interfaces may not include all elements shown in FIGS. 3-15 or may include other elements not shown in FIGS. 3-15. By the same token, the elements of a user interface may be arranged differently than shown in FIGS. 3-15. Additionally, user interfaces may be used to present other types of content, such as music, and may be used in conjunction with other types of devices, such as personal or laptop computers.

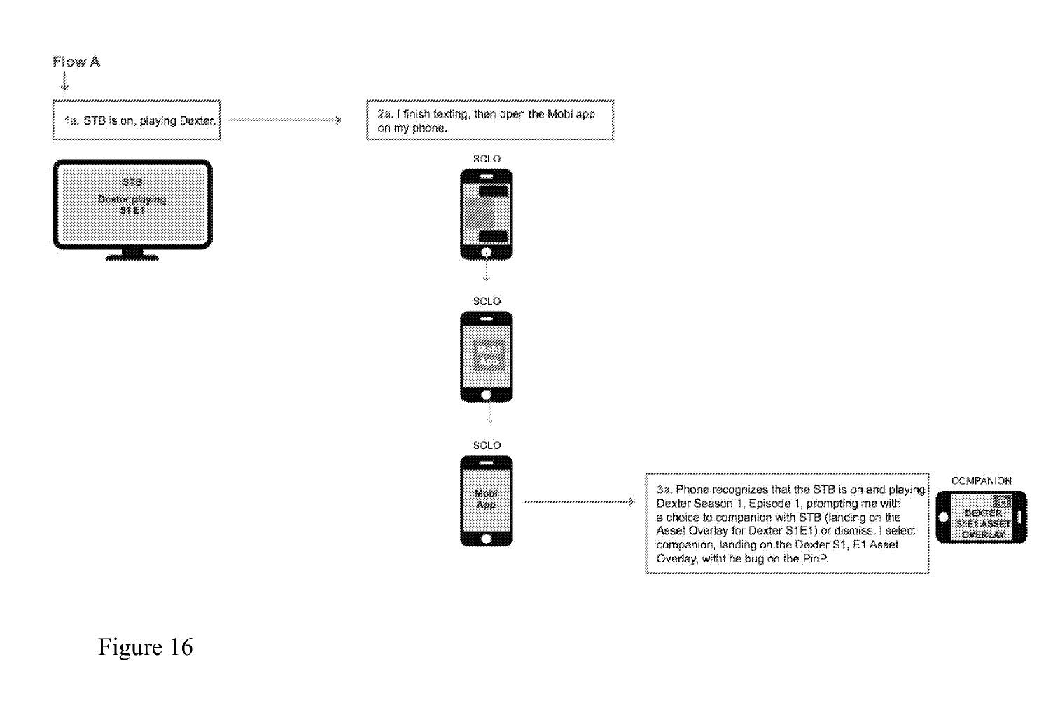

FIGS. 16-18 illustrate examples of techniques for communicating between various devices. In FIG. 16, a mobile device enters companion mode in communication with a television. According to various embodiments, companion mode may be used to establish a connected user interface across different devices. The connected user interface may allow a user to control presentation of media content from different devices, to view content across different devices, to retrieve content from different devices, and to access information or applications related to the presentation of content.

At operation 1a, an episode of the television show “Dexter” is playing on a television, which may also be referred to as a set top box (STB). According to various embodiments, the television show may be presented via any of various techniques. For instance, the television show may be received via a cable television network connection, retrieved from a storage location such as a DVR, or streamed over the Internet from a service provider such as Netflix.

According to various embodiments, the television or an associated device such as a cable box may be capable of communicating information to another device. For example, the television or cable box may be capable of communicating with a server via a network such as the Internet, with a computing device via a local network gateway, or with a computing device directly such as via a wireless network connection. The television or cable box may communicate information such as a current device status; the identity of a media content item being presented on the device, and a user account associated with the device.

At operation 2a, a communication application is activated on a mobile device that is not already operating in companion mode. The communication application may allow the mobile device to establish a communication session for the purpose of entering into a companion mode with other media devices. When in companion mode, the devices may present a connected user interface for cross-device media display. In the example shown in FIG. 16, the communication application is a mobile phone application provided by MobiTV.

At operation 3a, the mobile phone receives a message indicating that the television is active and is playing the episode of the television show “Dexter,” Then, the mobile phone presents a message that provides a choice as to whether to enter companion mode or to dismiss the connection. When the user selects companion mode, the mobile phone initiates the communications necessary for presenting the connected display. For example, the mobile phone may transmit a request to a server to receive the information to display in the connected display.

In particular embodiments, the connected display may present an asset overlay for the content being viewed. For example, the asset overlay may display information related to the viewed content, such as other episodes of the same television program, biographies of the cast members, and similar movies or television shows. In asset overlay user interface may include a screen portion for displaying a small, thumbnail image sized video of the content being presented on the television. Then, the user can continue to watch the television program even while looking at the mobile phone.

In particular embodiments, a device may transmit identification information such as a user account identifier. In this way, a server may be able to determine how to pair different devices when more than one connection is possible. When a device is associated with a user account, the device may display information specific to the user account such as suggested content determined based on the user's preferences.

In some embodiments, a device may automatically enter companion mode when an available connection is located. For instance, a device may be configured in an “auto-companion” mode. When a first device is in auto-companion mode, opening a second device in proximity to the first device causes the first device to automatically enter companion mode, for instance on the asset overlay page. Dismissing an alert message indicating the possibility of entering companion mode may result in the mobile phone returning to a previous place in the interface or in another location, such as a landing experience for a time-lapsed user. In either case, the television program being viewed on the television may be added to the history panel of the communication application.

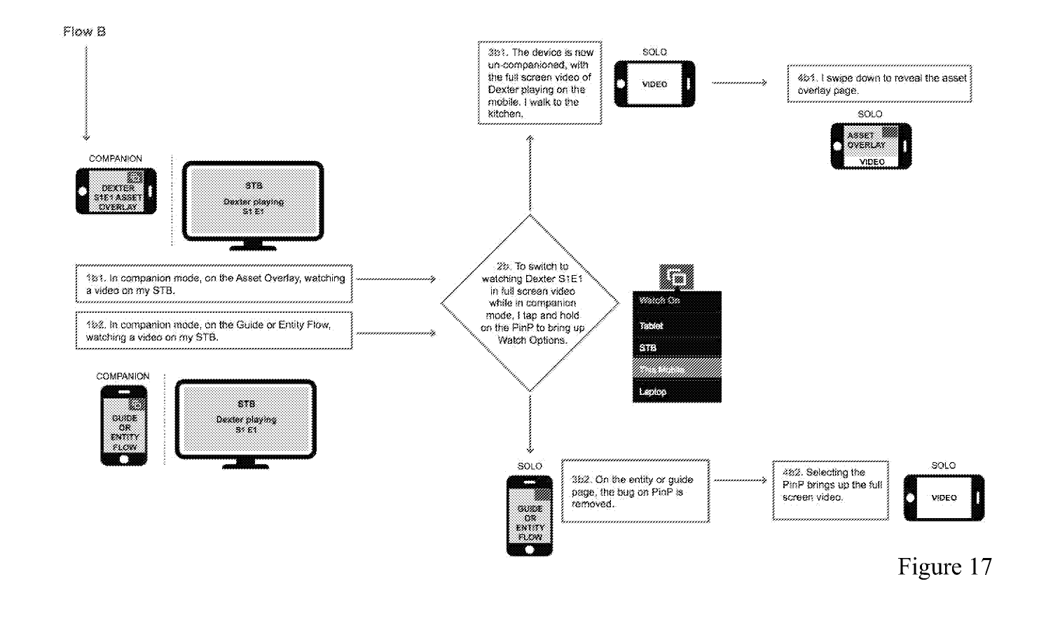

In FIG. 17, techniques for displaying a video in full screen mode on a mobile device while the mobile device is in companion mode. Initially, the television is displaying an episode of the “Dexter” television show. At the same time, the mobile device is operating in companion mode. When the video is displayed in full screen mode, the user can, for instance, take the mobile device to a different location while continuing to view the video.

At operation 1b1, the mobile device is displaying an asset overlay associated with the television program as discussed with respect to FIG. 12. At operation 2b1, the mobile device is displaying an electronic program guide or an entity flow as discussed with respect to FIGS. 13-15. In both operations, the mobile device is also displaying a small, picture-in-picture version of the television show displayed on the television screen.

At operation 2b, the user would like to switch to watching the television program in full screen video on the mobile device while remaining in companion mode. In order to accomplish this task, the user activates a user interface element, for instance by tapping and holding on the picture-in-picture portion of the display screen. When the user activates the selection interface, the mobile device displays a list of devices for presenting the content. At this point, the user selects the mobile device that the user is operating.

At operation 3b1, the device is removed from companion mode. When companion mode is halted, the video playing on the television may now be presented in the mobile device in full screen. According to various embodiments, the device may be removed from proximity of the television while continuing to play the video.

At operation 4b1, the user selects the asset overlay for display on top of, or in addition to, the video. According to various embodiments, various user interface elements may be used to select the asset overlay for display. For example, the user may swipe the touch screen display at the mobile device. As another example, the user may click on a button or press a button on a keyboard.

At operation 3b2, the electronic program guide or entity flow continues to be displayed on the mobile device. At the same time, the “bug” is removed on the picture-in-picture portion of the display screen. As used herein, the term “bug” refers to an icon or other visual depiction. In FIG. 17, the bug indicates that the mobile device is operating in companion mode. Accordingly, the removal of the bug indicates that the device is no longer in companion mode.

At operation 4b2, the video is displayed in full screen mode. According to various embodiments, the video may be displayed in full screen mode by selecting the picture-in-picture interface. Alternately, the video may be automatically displayed in full screen mode when the device is no longer operating in companion mode.

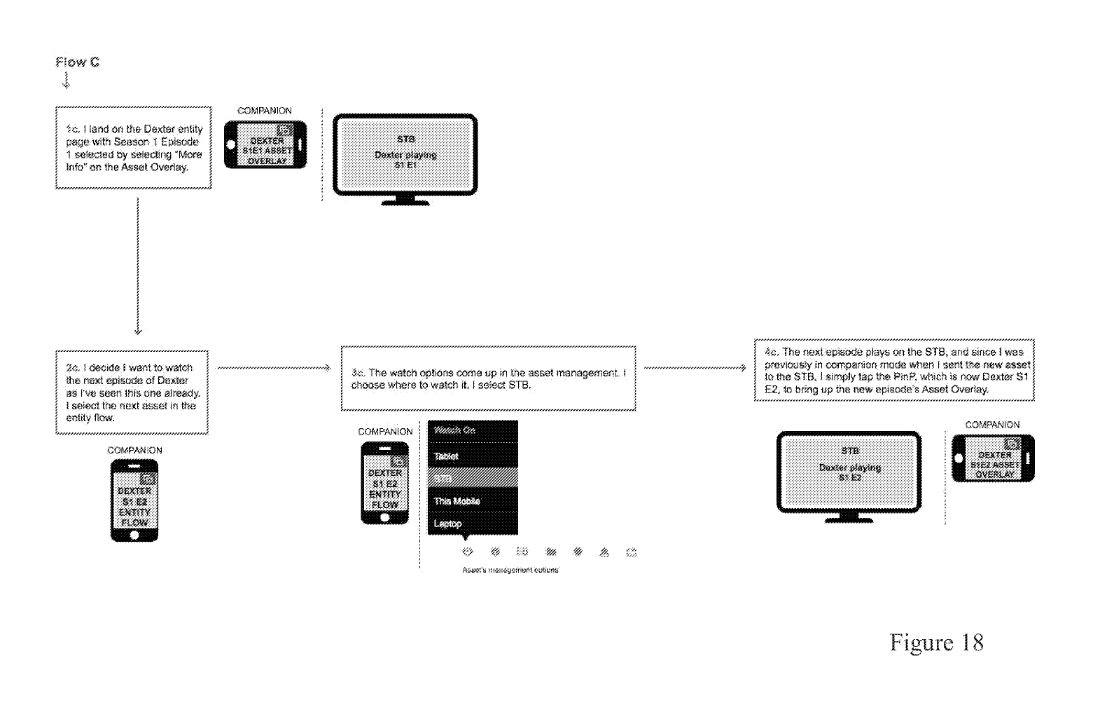

In FIG. 18, the user selects content by operating the media content asset and element navigation screen. As discussed with respect to FIG. 4, in particular embodiments a media content item may be a media content entity or a media content asset. A media content asset may be any discrete item of media content capable of being presented on a device. A media content entity may be any category, classification, container, or other data object capable of containing one or more media content assets or other media content entities.

At operation 1c, the user is viewing an episode of the television program “Dexter” on a television. At the same time, a mobile device configured for companion mode is displaying an asset overlay containing content related to the television program as well as a picture-in-picture of the television program. The user navigates to an entity page associated with the program, as discussed with respect to FIG. 4, by selecting a “More Info” navigation element displayed on the asset overlay page.

At operation 2c, the user selects the next episode of “Dexter” within the entity page, in the entity page associated with “Dexter”, each episode may be referred to as an asset.

At operation 3c, the mobile device displays options for presenting the selected episode. In FIG. 18, the display options include a tablet computer, the television, the mobile device, and a laptop computer. However, when different devices are available, other devices may be included in the display options. When the user selects the display option associated with the television, or STB, an instruction is transmitted to the television or an associated control device such as a cable box or satellite box to play the selected episode.

At operation 4c, the selected episode is displayed on the television. To display the selected episode, content may be retrieved from any of various sources, such as an Internet content service provider, a satellite or cable content service provider, or a local or remote storage location. Since the mobile device was previously configured for companion mode prior to sending the instruction to present the media content asset on the television, the mobile device may be configured for presenting related information on the mobile device. In particular embodiments, an asset overlay with a picture-in-picture component may be displayed automatically. Alternately, the user may activate a user interface element, for instance by tapping the picture-in-picture component, to activate the asset overlay.

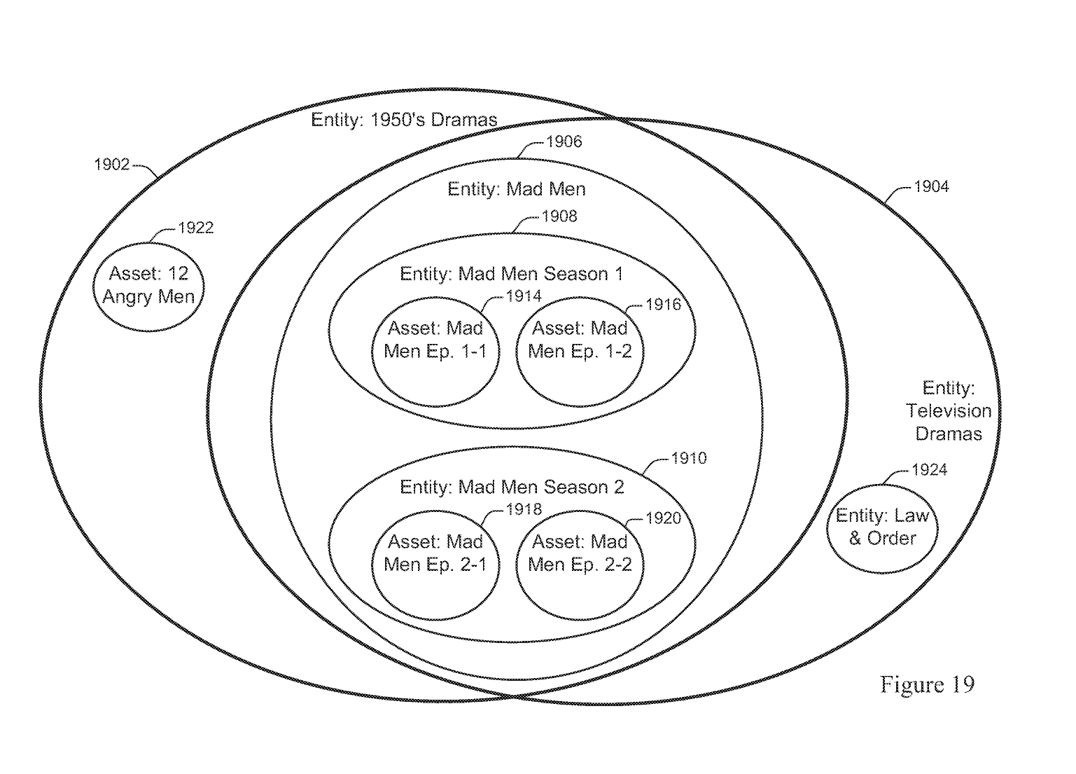

FIG. 19 illustrates a diagram of an example media content data structure. According to various embodiments, a media content data structure may be used to organize media content for navigation, browsing, searching, filtering, selection, and presentation in a user interface. As discussed herein, media content may be organized in a flexible way that can be adapted to different types of media content. The media content data structure shown in FIG. 19 includes media content entities 1902-1910 and 1924. The media content data structure also includes media content assets 1914-1924.

According to various embodiments, a media content asset may identify any media content item that may be presented at a media content presentation device. For instance, a media content item may be a video and/or audio file or stream. A media content presentation device may include an device capable of presenting a media content item, such as a television, laptop computer, desktop computer, tablet computer, mobile phone, or any other capable device.

According to various embodiments, a media content asset may take any of various forms. For example, a media content asset may represent a media stream received via a network from a content service provider or another content source. As another example, a media content asset may represent a discrete file or files. In this case, the media content asset may be stored on a local storage medium, stored on a network storage device, downloaded from a service provider via a network, or accessed in any other way.

FIG. 19 shows five examples of assets. These include four assets 1914-1920 representing four episodes of the television program “Mad Men” as well as one asset 1922 representing the movie “12 Angry Men,”

According to various embodiments, a media content entity may be a category, container, or classification that may include media content assets and/or other media content entities as members. FIG. 19 shows six media content entities 1902-1910 and 1924.

According to various embodiments, membership in a media content entity is not exclusive. That is, an asset or entity that is a member of a media content entity may be a member of another media content entity. By the same token, the membership of one media content entity may overlap with the membership of another media content entity.

As discussed herein, media content entities can contain other media content entities. For example, the media content entity 1906 represents the television program Mad Men. Accordingly, the media content entity 1906 includes two entities 1908 and 1910 that correspond to Season 1 and Season 2 of Mad Men. These in turn contain media content assets. The media content entity 1908 includes the two media content assets 1911 and 1916, which correspond to the first two episodes of Season 1 of Mad Men. Similarly, the media content entity 1910 includes the two media content assets 1918 and 1920, which correspond to the first two episodes of Season 2 of Mad Men. The entities shown in FIG. 19 may include many assets not shown in FIG. 19. For instance, the entities 1908 and 1910 may include many additional episodes, and the entity 1906 may include many additional seasons of the television program.

According to various embodiments, media content entities may have overlapping sets of content. For example, the entity 1906 corresponding to Mad Men is included within both the entity 1902 corresponding to 1950's Dramas and the entity 1904 corresponding to Television Dramas.

According to various embodiments, when media content entities overlap, one need not be a subset of the other. For instance, although both the entity 1902 and the entity 1904 include the entity 1906, each also includes entities that the other does not. The entity 1902, but not the entity 1904, includes the asset 1922 corresponding to the movie 12 Angry Men, which is a 1950's drama but is not a television drama. Similarly, the entity 1904, but not the entity 1902, includes the asset 1924 corresponding to the television program Law & Order, which is a television drama but is not set in the 1950's.

According to various embodiments, a media content entity may be relatively fixed in terms of its contents. For instance, the entity 1908 corresponding to Mad Men season 1 may include all of the episodes within season 1 for all subscribers.

According to various embodiments, a media content entity may be relatively fluid in terms of its contents. For example, the items included within a media content entity may be tailored to the preferences of a particular individual. In this case, a media content entity such as the entity 1902 corresponding to 1950's Dramas may include different assets and entities for different individuals based on those individuals' preferences. As another example, a media content entity such as the entity 1904 corresponding to Television Dramas may have contents that change to reflect the changing nature of television programming New programs may be periodically added, while unpopular or re-categorized programs may be periodically removed.

According to various embodiments, the contents of a media content entity may be changed based on availability. For example, a content service provider such as Netflix may remove a movie such as 12 Angry Men from its list of offerings. In this case, the contents of the entity 1902 may be changed to reflect this removal. However, if the movie is available from another source, then the asset may be left to remain within the entity 1902. As another example, entities provided to a designated user may be updated so that the user sees only assets that are actually accessible to the user given the user's media content subscriptions, permissions, and content. For instance, a user accessing the media content interface may choose to stop paying for a particular content service, such as Netflix. In this case, assets available only from Netflix may be removed from media content entities presented to the user.

In particular embodiments, all entities may be members of a base entity. The base entity may include all entities and assets available on the system. Alternately, the base entity may include all entities and assets available to a designated user or group of users.

According to various embodiments, media content entities may be used to search, sort, or filter media content. For example, in FIG. 19, a user who wishes to view a particular category of media content could select the media content entity 1902 to filter out all content other than 1950's dramas. As another example, a user who wishes to view a particular type of media could select both the media content entity 1902 and the media content entity 1904 to show all 1950's dramas and all television dramas but exclude other types of content, such as dramas outside these categories.

According to various embodiments, media content entities may reflect the availability of various content on different devices. For instance, in some cases cable television content may only be available for viewing on a television, not on a computer. At the same time, content from an Internet content service provider such as Netflix may not be available on some mobile device. In such a situation, a user may have access to a media content entity that includes all of the content available on a particular device or group of devices. In this way, the user may more readily select content for presentation on a particular device.

FIGS. 20-32 illustrate images of examples of content management user interfaces. The content management user interface may also be referred to herein as an asset overlay. The asset overlay may correspond to a current asset or content item being presented. The asset overlay may present information related to the asset, such as links to other seasons or episodes of a television show, sequels or prequels of a movie, cast member biographies, and any other relevant information.

In FIGS. 20-32, the content management user interface is presented on a mobile device. According to various embodiments, however, an asset overlay may be presented on any of a variety of devices such as computers, televisions, and other mobile devices. In particular embodiments, the asset overlay may correspond to a current asset or content item being presented on a different device, such as a television in communication with a mobile device. Accordingly, the asset overlay may be presented within a connected user interface that may itself be presented on any of a variety of devices, as discussed herein.

In FIG. 20, the content management user interface shows information related to the television show Dexter. For instance, in FIG. 20, the user may be watching the television program Dexter. The television program may be presented on the mobile device itself or on another device, such as a television displaying a connected user interface in communication with the mobile device.

The content management user interface in FIG. 20 includes representations of entities corresponding to the different seasons of Dexter as well as an asset corresponding to the next episode following the current episode. In addition, the content management user interface in FIG. 20 includes a picture or video corresponding to the entity represented by the

The content management user interface in FIG. 20 includes a picture-in-picture portion. According to various embodiments, a picture-in-picture portion can be expanded. For instance, on a touch screen display, a user may touch the corners of the picture-in-picture portion and slide the corners apart to enlarge the content shown there.

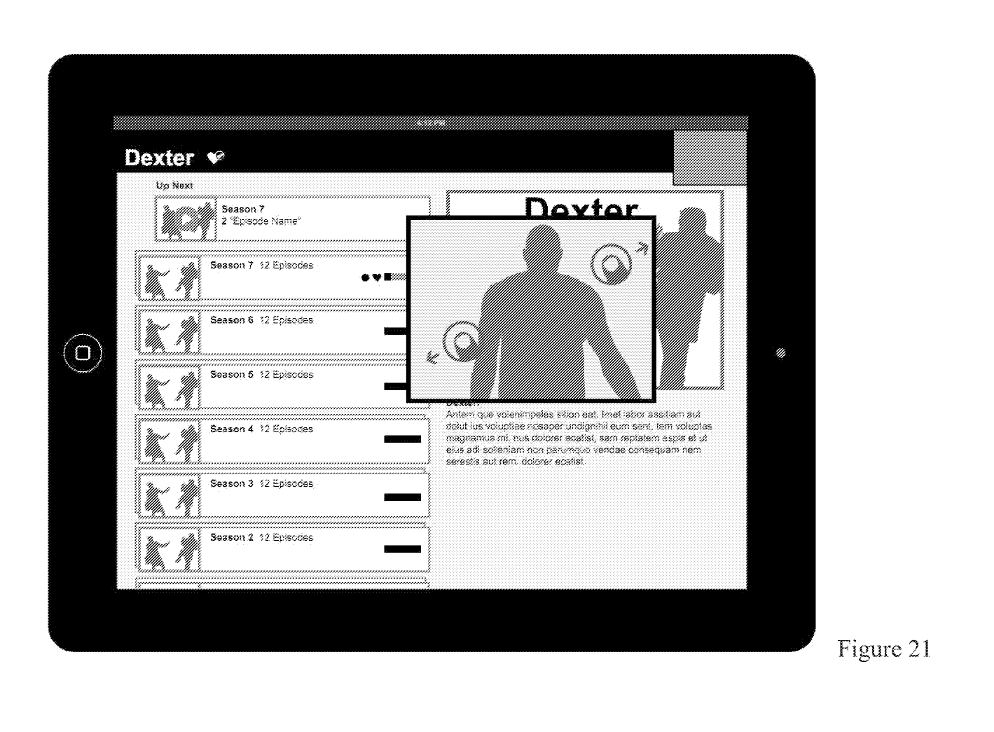

For example, the asset overlay shown in FIG. 21 is similar to the asset overlay shown in FIG. 20. However, in FIG. 21, the picture-in-picture portion is expanded and moved to cover a larger portion of the asset overlay. In particular embodiments, the content may be presented in full screen or in any portion of the display screen.

According to various embodiments, an asset overlay may include content control elements. Content control elements may be used to control the presentation of content on the device on which the control elements are displayed or on another device. For instance, content control elements may be used to control the playback of content on a device such as a television in communication with a mobile device on which the content control elements are displayed. In this way, a mobile device can act as a remote control for a television or other device. By activating a connected user interface on the different devices and establishing a communication link, control and presentation of content may be unified.

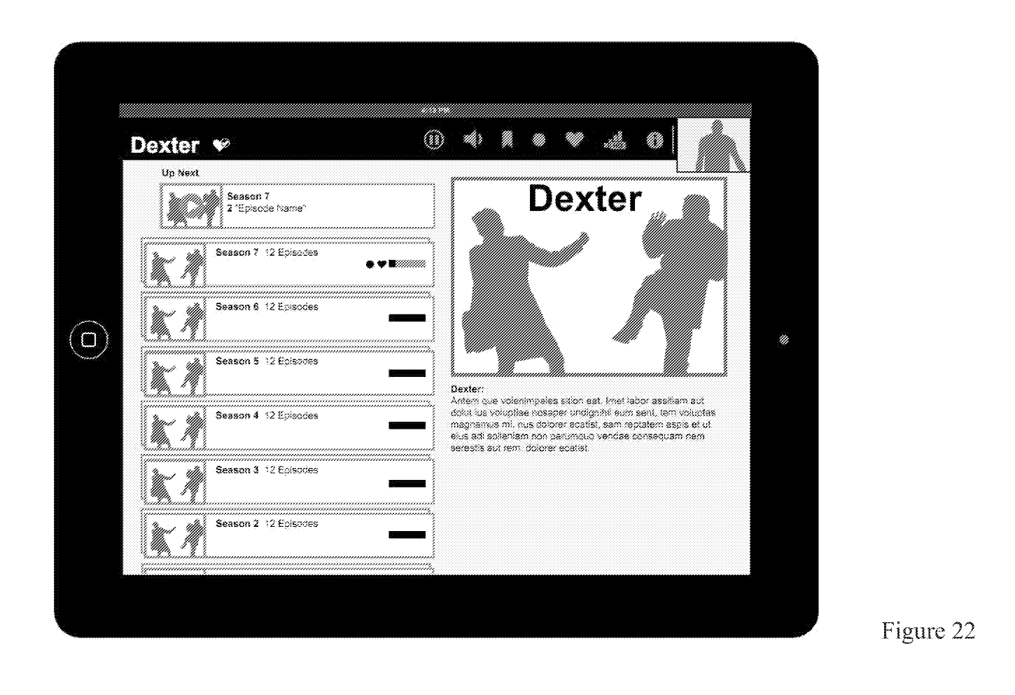

In FIG. 22, the content control elements may be used to pause the playback of content, adjust the volume of content, bookmark the content for later access, record the content, indicate a preference for the content, adjust the resolution or data rate at which the content is received or presented, and receive information regarding the content. According to various embodiments, however, fewer, additional, or different content control elements may be used. For instance, content control elements may include elements for fast forwarding, zooming, or other such actions.

According to various embodiments, a content management user interface may include a discover interface for discovering new content. In some instances, the discover interface may present content related to the content described in the content management user interface. For instance, the related content may be content directed to the same subject, content with similar cast members, or content categorized within the same genre.

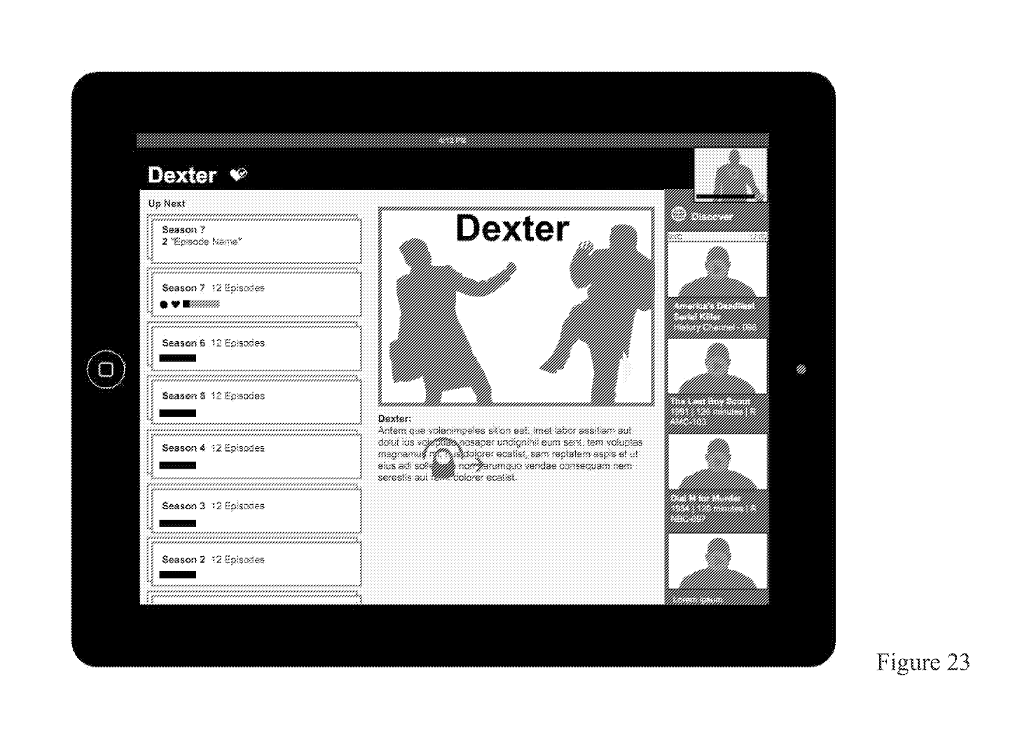

For example, in FIG. 23, the content management interface includes a discover interface for discovering new content related to the television program Dexter, which relates to a serial killer of the same name. Accordingly, the discover interface includes content such as a documentary on serial killers and movies directed to similar topics.

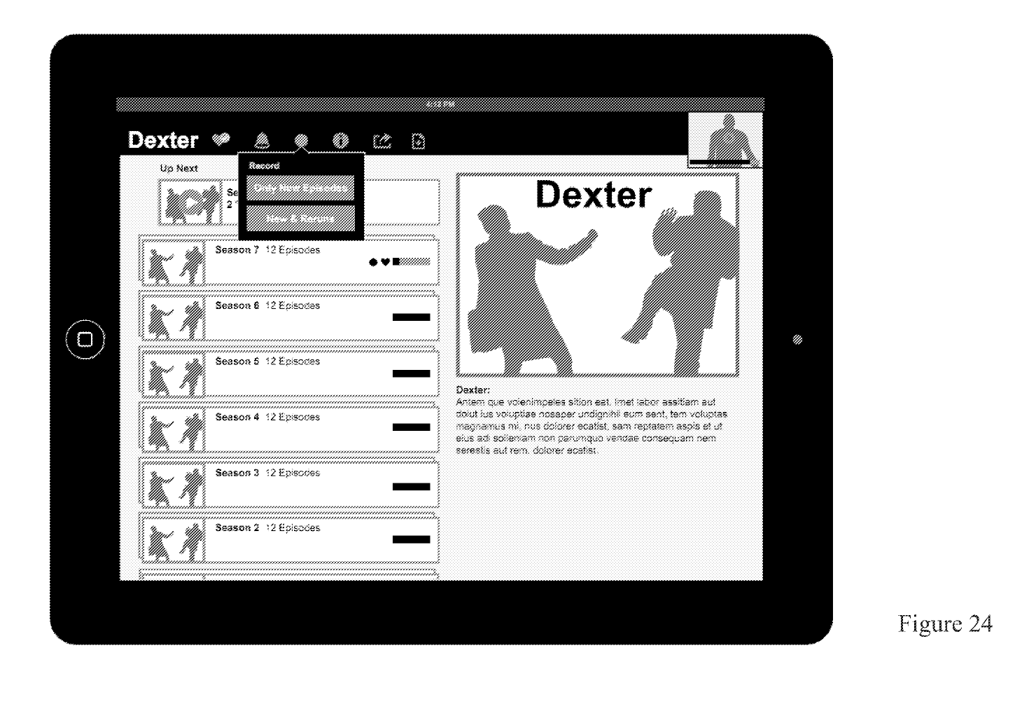

According to various embodiments, a content management user interface may include entity control elements. Entity control elements may include actions that may be performed with respect to a media content entity. For instance, in FIG. 24, the content management user interface includes entity control elements for expressing a preference for an entity, establishing an alarm for time-sensitive content related to the entity, recording assets included within the entity, presenting information relating to an entity, and other such operations. In some cases, entity control elements may themselves be associated with options or actions. For instance, the recording element allows a user to select between recording only new episodes and recording both new episodes and reruns.

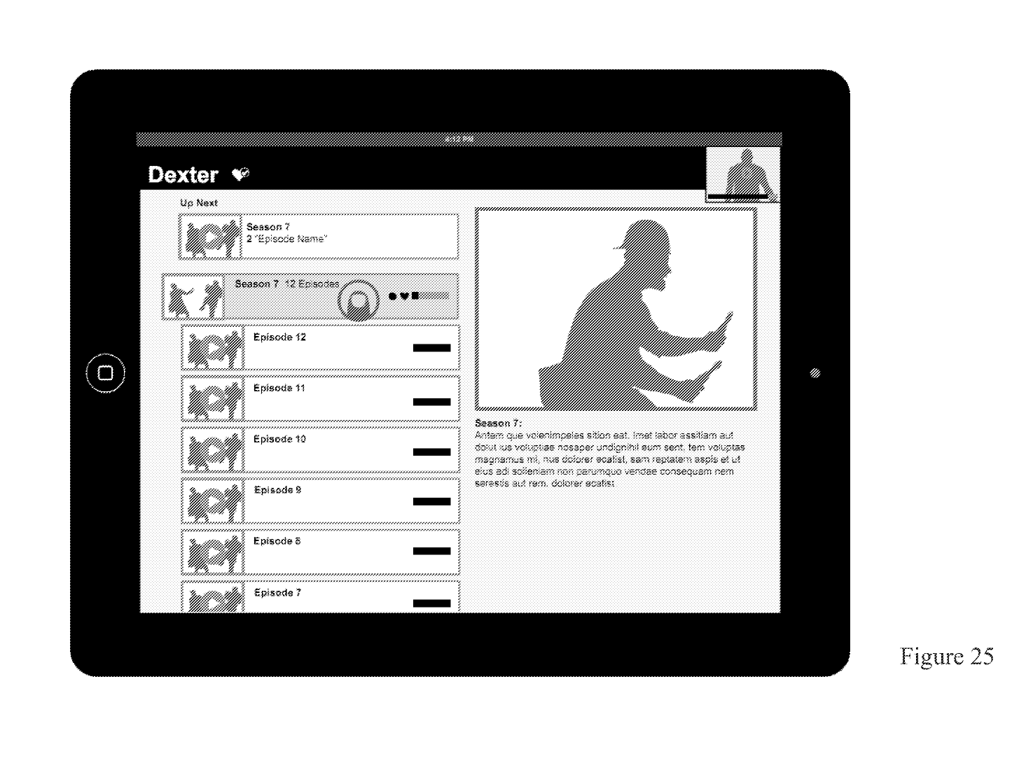

According to various embodiments, a media content entity displayed within a content management user interface may be expanded to display entities or assets included within the entity. For instance, an entity corresponding to a season of a television show may be expanded to display the episodes included within the entity. In FIG. 25, the Season 7 entity corresponding to season 7 of the television program Dexter is expanded to show the episodes included within the season.

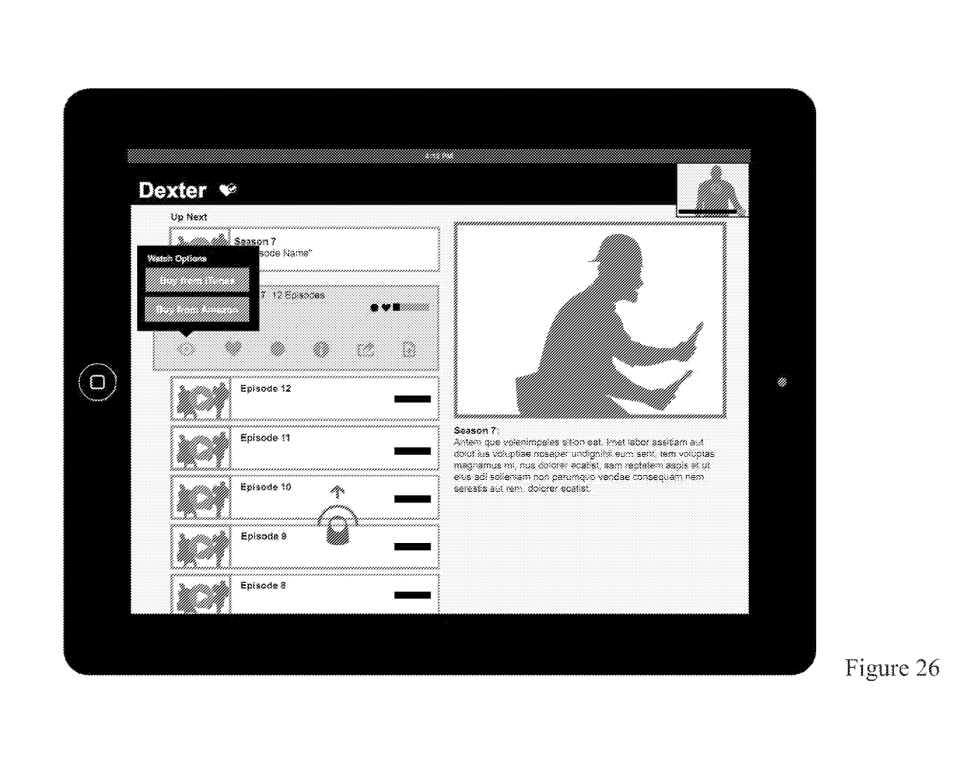

According to various embodiments, a media content entity or asset may be associated with various options or actions within the user interface. For instance, a media content asset may be associated with options or actions for acquiring the media content, in FIG. 26, the entity corresponding to season 7 of Dexter is expanded to show the episodes in season 7. Further, the content management interface is presenting options for watching season 7. In FIG. 26, these options including buying the season from iTunes or Amazon. However, in some cases different options may be present. For example, if Dexter is available on Netflix, then the watch options may include an option to view on Netflix. As another example, if new episodes or reruns of Dexter appear on television, then the watch options may include an option to record the episodes when they appear.

According to various embodiments, a media content data structure may be configured in a particular way to correspond to a particular type of media content. For instance, movies, episodic television programs, sports content, talk shows, and other types of content may be associated with different media content data structures. These data structures may be reflected within the media content management or asset overlay user interface. For instance, a media content management interface corresponding to an entity may display assets or entities that are members of the parent entity.

For example, the FIGS. 20-26 show media content management interfaces corresponding to the Dexter television program. Since Dexter is an episodic television program, the entity corresponding to Dexter may include as members entities corresponding to the seasons of Dexter and assets corresponding to episodes of Dexter. Accordingly, the media content management interface corresponding to Dexter includes these elements.

In particular embodiments, a media content asset may be presented within the content management user interface along with various types of information describing the asset. For example, a page for a media content asset associated with a movie may include other videos related to the movie, such as extras, bonus materials, documentaries regarding the making of the movie, and other such content. As another example, a page for such a media content asset may include details regarding the asset, such as ratings of the movie, biographies of the movie's cast or crew members, tags or categories that have been applied to the movie, social media information regarding the movie, and other such information. As yet another example, a page for such a media content asset may include a description and/or one or more images or movie clips corresponding to the media content asset.

According to various embodiments, a talk show may be associated with a particular media content data structure. For instance, an entity corresponding to a particular talk show may include entities corresponding to previous episodes of the talk show and upcoming episodes of the talk show. For each episode, information may be provided regarding guests that appear on the talk show.

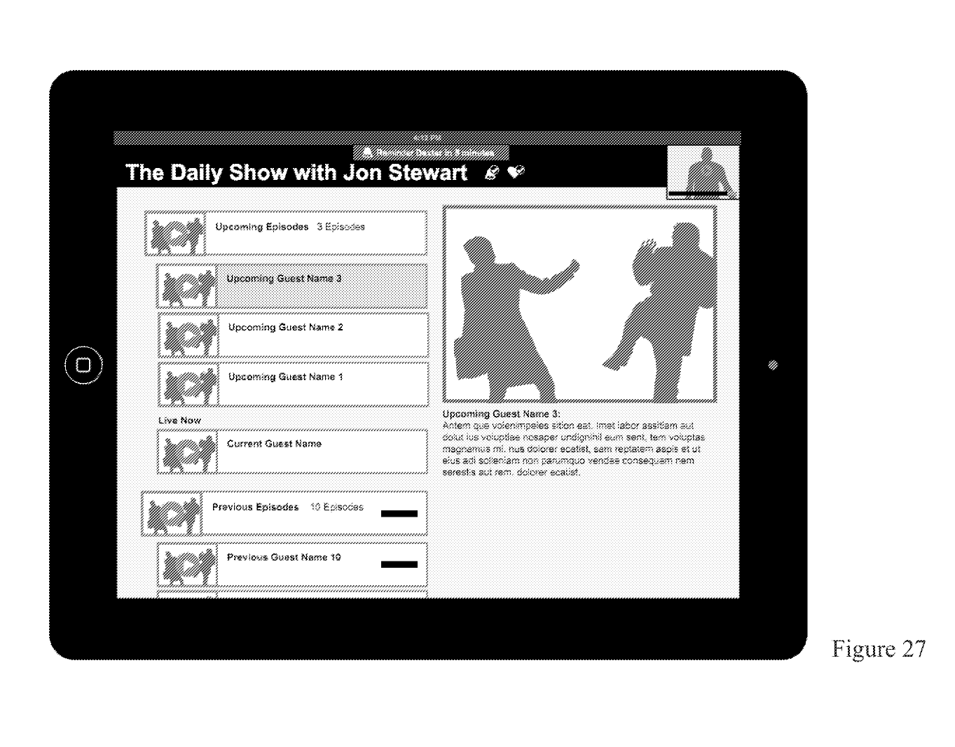

For example, in FIG. 27, a media content management interface corresponding to The Daily Show with Jon Stewart is shown. In FIG. 27, an element for an entity corresponding to upcoming episodes is shown. The element is expanded to show the guests that will appear in the upcoming episodes. In addition, an element is shown that identifies the currently playing episode as well as the guest in the current episode. Also, an element for an entity corresponding to previous episodes is shown. Finally, an alarm at the top of the user interface serves as a reminder that an episode of Dexter will soon be presented in a time-sensitive format such as broadcast television. As discussed herein, the content management user interface may allow a user to establish alerts and reminders for time-sensitive content.

According to various embodiments, the episodes may be available from various sources, such as DVR, broadcast television, Netflix, iTunes, or other sources. In addition, the episodes may be presented on various devices, such as a television, a mobile device, or a laptop computer. In this way, a user can interact with the content associated with the program, while the details such as a source of the content and the device on which the content is viewed are de-emphasized.

According to various embodiments, a sport may be associated with a particular media content data structure. For instance, an entity corresponding to a particular professional sport may include an entity corresponding to games that are being presented at a particular point in time via a broadcast transmission technique such as cable television, an entity corresponding to upcoming games that will be presented in the future, an entity corresponding to recorded games, and other such entities.

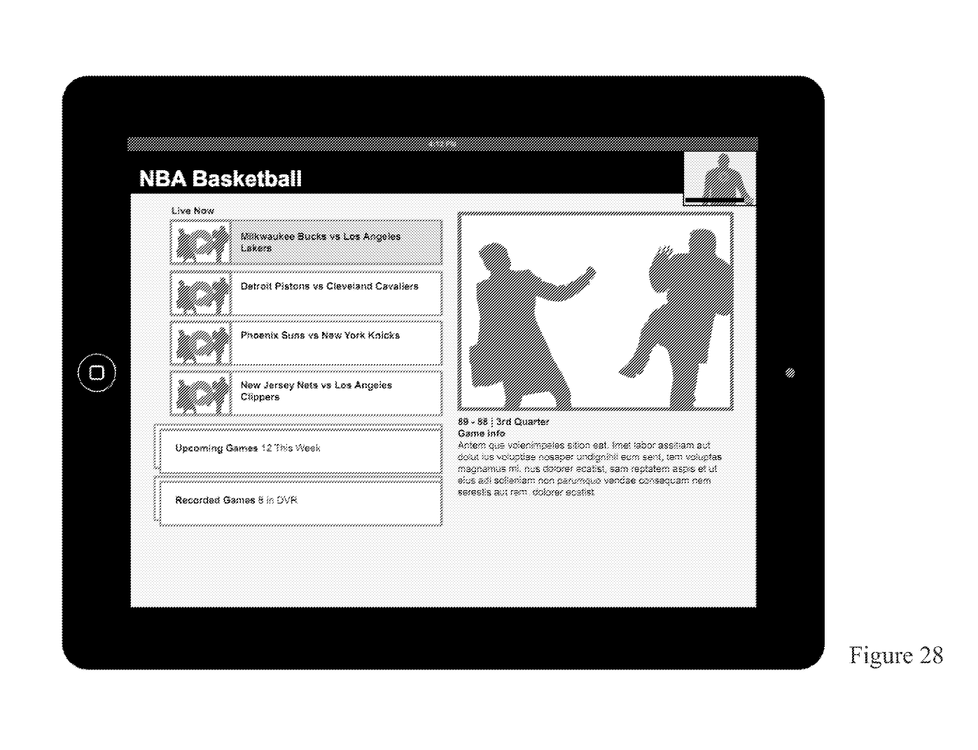

For example, FIG. 28 shows a content management interface associated with an entity corresponding to National Basketball Association (NBA) basketball. Accordingly, the content management interface includes information such as games that are currently being presented on television, games that will be presented in the next week on television, and games that have been recorded on the user's digital video recorder (DVR). In addition, the content management interface includes information regarding a current game, such as the game score, the current quarter of the game, and information regarding the game.

According to various embodiments, a content management interface corresponding with a sport may include other information. For instance, such a content management interface may include a link to an entity showing movies or documentaries relating to the game. Such movies or documentaries may be available from sources other than broadcast television, such as the user's personal movie library, an online subscription-based content service provider such as Netflix, or an online content library such as iTunes.

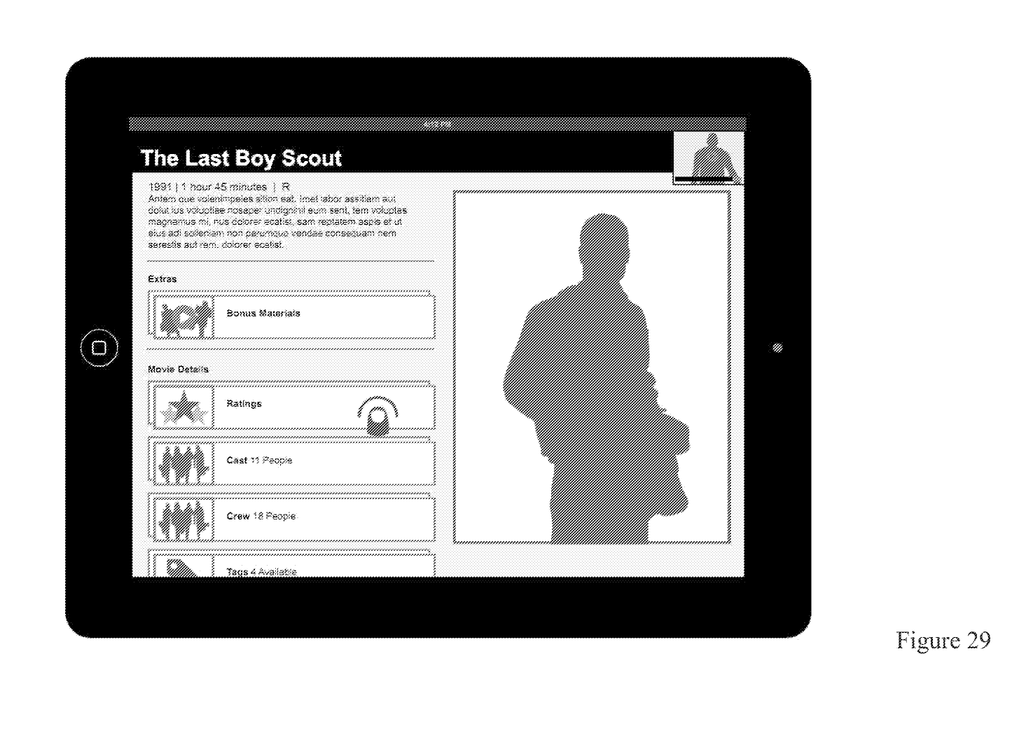

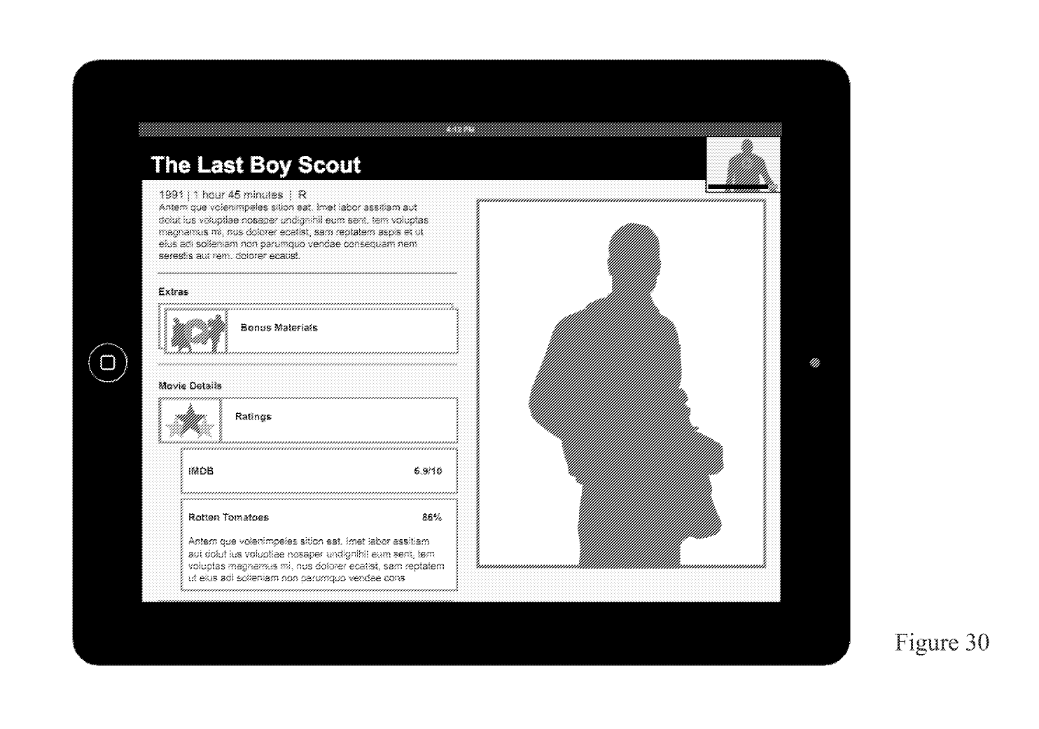

In FIGS. 29 and 30, the content management user interface is presenting information related to the media content asset corresponding to the movie The Last Boy Scout. The page presented in FIG. 29 includes an example image associated with the movie, extras and bonus materials associated with the movie, ratings of the movie, biographies of the movie's cast or crew members, and tags or categories that have been applied to the movie. In FIG. 30, the ratings category is expanded to show ratings provided by various entities such as IMDB and Rotten Tomatoes.

According to various embodiments, the asset structure for a series of movies may include all of the movies in the series within an entity corresponding to the series as a whole. Also, the first movie in the series or the next unwatched movie may be designated in a manner similar to a television series. Finally, the content management interface may present information such as cast biographies, documentaries related, to the movie series, and a description of the movie series.

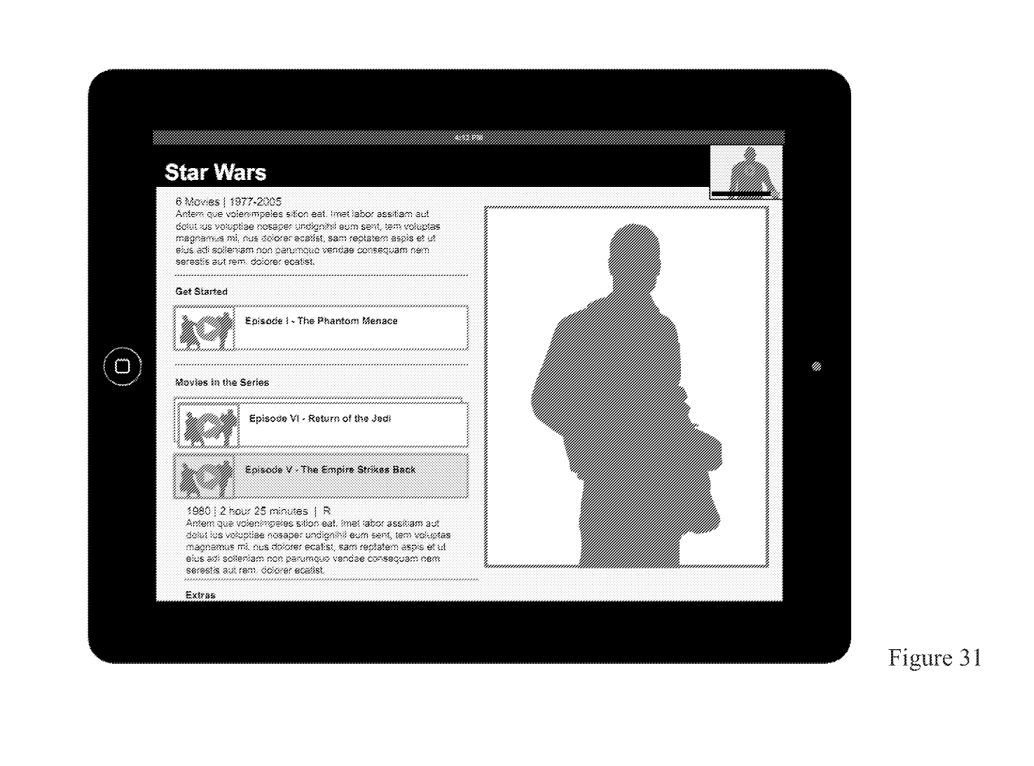

For example, in FIG. 31, a content management interface relating to the Star Wars series of movies is shown. The content management interface shows the first movie in the series as well as a list of other movies in the series. A description of the series and of each movie is also provided.

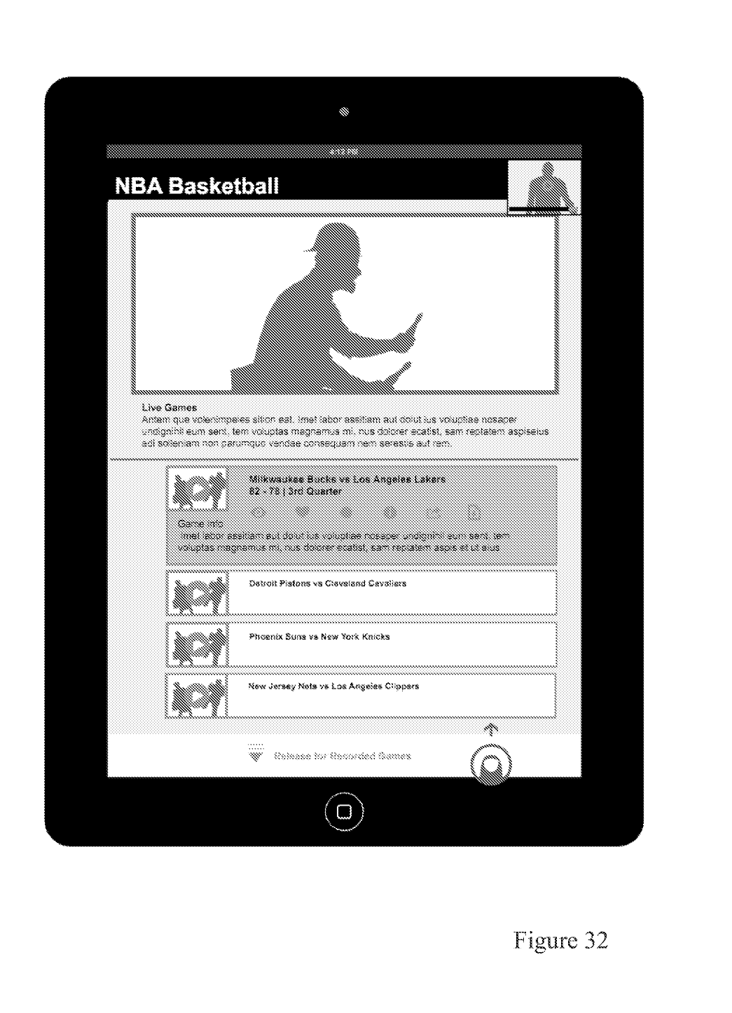

According to various embodiments, a content management user interface may be arranged in either landscape or portrait orientation. For instance, in FIG. 32, a content management interface relating to NBA basketball is shown arranged in a portrait orientation.

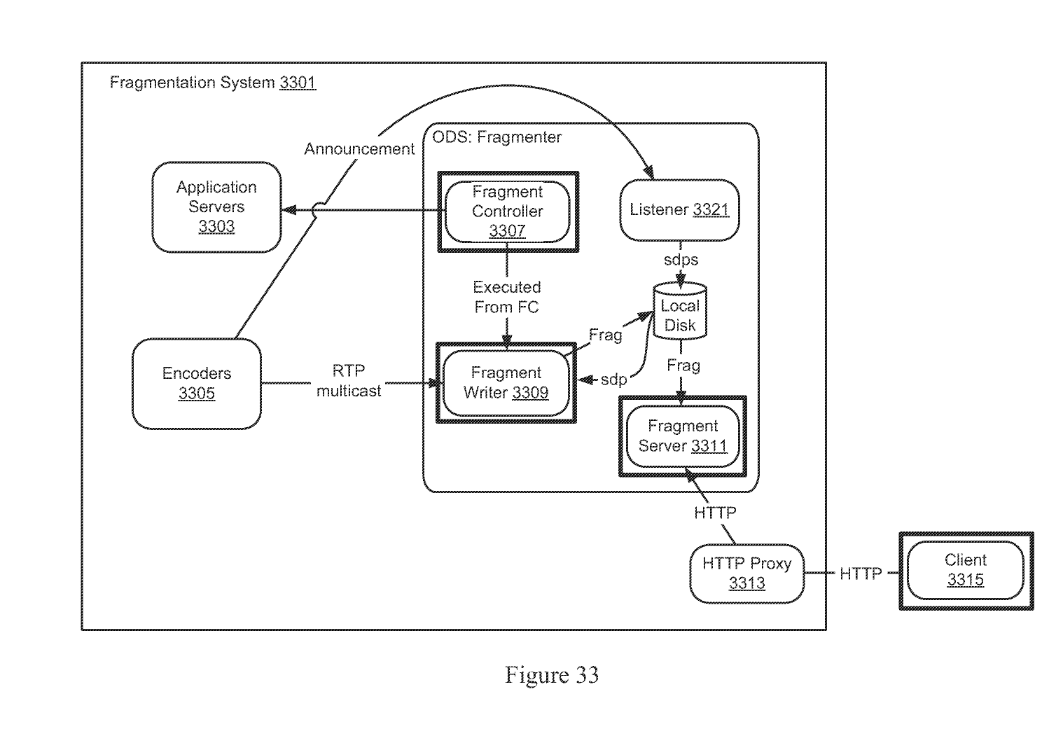

FIG. 33 is a diagrammatic representation illustrating one example of a fragment or segment system 3301 associated with a content server that may be used in a broadcast and unicast distribution network. Encoders 3305 receive media data from satellite, content libraries, and other content sources and sends RTP multicast data to fragment writer 3309. The encoders 3305 also send session announcement protocol (SAP) announcements to SAP listener 3321. According to various embodiments, the fragment writer 3309 creates fragments for live streaming, and writes files to disk for recording. The fragment writer 3309 receives RTP multicast streams from the encoders 3305 and parses the streams to repackage the audio/video data as part of fragmented MPEG-4 files. When a new program starts, the fragment writer 3309 creates a new MPEG-4 file on fragment storage and appends fragments. In particular embodiments, the fragment writer 3309 supports live and/or DVR configurations.

The fragment server 3311 provides the caching layer with fragments for clients. The design philosophy behind the client/server application programming interface (API) minimizes round trips and reduces complexity as much as possible when it comes to delivery of the media data to the client 3315. The fragment server 3311 provides live streams and/or DVR configurations.

The fragment controller 3307 is connected to application servers 3303 and controls the fragmentation of live channel streams. The fragmentation controller 3307 optionally integrates guide data to drive the recordings for a global/network DVR. In particular embodiments, the fragment controller 3307 embeds logic around the recording to simplify the fragment writer 3309 component. According to various embodiments, the fragment controller 3307 will run on the same host as the fragment writer 3309. In particular embodiments, the fragment controller 3307 instantiates instances of the fragment writer 3309 and manages high availability.

According to various embodiments, the client 3315 uses a media component that requests fragmented MPEG-4 files, allows trick-play, and manages bandwidth adaptation. The client communicates with the application services associated with HTTP proxy 3313 to get guides and present the user with the recorded content available.

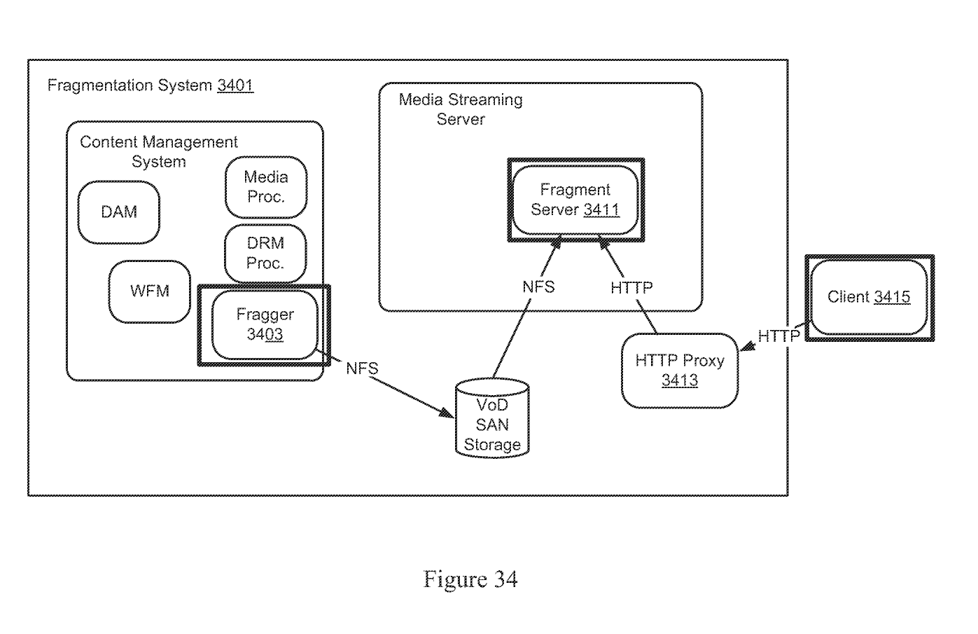

FIG. 34 illustrates one example of a fragmentation system 3401 that can be used for video-on-demand (VoD) content. Fragger 3403 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 3411 provides the caching layer with fragments for clients. The design philosophy behind the client/server API minimizes round trips and reduces complexity as much as possible when it comes to delivery of the media data to the client 3415. The fragment server 3411 provides VoD content.

According to various embodiments, the client 3415 uses a media component that requests fragmented MPEG-4 files, allows trick-play, and manages bandwidth adaptation. The client communicates with the application services associated with HTTP proxy 3413 to get guides and present the user with the recorded content available.

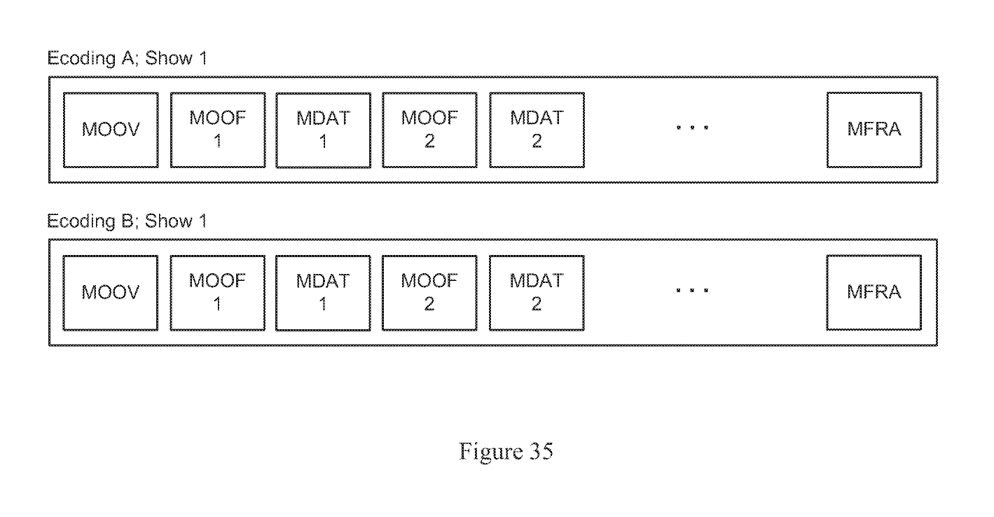

FIG. 35 illustrates examples of files stored by the fragment writer. According to various embodiments, the fragment writer is a component in the overall fragmenter. It is a binary that uses command line arguments to record a particular program based on either NTP time from the encoded stream or wallclock time. In particular embodiments, this is configurable as part of the arguments and depends on the input stream. When the fragment writer completes recording a program, it exits. For live streams, programs are artificially created to be short time intervals e.g. 5-15 minutes in length.

According to various embodiments, the fragment writer command line arguments are the SDP file of the channel to record, the start time, end time, name of the current and next output tiles. The fragment writer listens to RTP traffic from the live video encoders and rewrites the media data to disk as fragmented MPEG-4. According to various embodiments, media data is written as fragmented MPEG-4 us defined in MPEG-4 part 12 (ISO/IEC 14496-12). Each broadcast show is written to disk as a separate file indicated by the show ID (derived from EPG). Clients include the show ID as part of the channel name when requesting to view a prerecorded show. The fragment writer consumes each of the different encodings and stores them as a different MPEG-4 fragment.

In particular embodiments, the fragment writer writes the RIP data for a particular encoding and the show ID field to a single file. Inside that file, there is metadata information that describes the entire file (MOOV blocks). Atoms are stored as groups of MOOF/MDAT pairs to allow a show to be saved as a single tile. At the end of the file there is random access information that can be used to enable a client to perform bandwidth adaptation and trick play functionality.

According to various embodiments, the fragment writer includes an option which encrypts fragments to ensure stream security during the recording process. The fragment writer will request an encoding key from the license manager. The keys used are similar to that done for DRM. The encoding format is slightly different where MOOF is encoded. The encryption occurs once so that it does not create prohibitive costs during delivery to clients.

The fragment server responds to HTTP requests for content. According to various embodiments, it provides APIs that can be used by clients to get necessary headers required to decode the video and seek any desired time frame within the fragment and APIs to watch channels live. Effectively, live channels are served from the most recently written fragments for the show on that channel. The fragment server returns the media header (necessary for initializing decoders), particular fragments, and the random access block to clients. According to various embodiments, the APIs supported allow for optimization where the metadata header information is returned to the client along with the first fragment. The fragment writer creates a series of fragments within the file. When a client requests a stream, it makes requests for each of these fragments and the fragment server reads the portion of the file pertaining to that fragment and returns it to the client.

According to various embodiments, the fragment server uses a REST API that is cache-friendly so that most requests made to the fragment server can be cached. The fragment server uses cache control headers and ETag headers to provide the proper hints to caches. This API also provides the ability to understand where a particular user stopped playing and to start play from that point (providing the capability for pause on one device and resume on another).

In particular embodiments, client requests for fragments follow the following format:

http://{HOSTNAME}/frag/{CHANNEL}/{BITRATE}/[{ID}/]
{COMMAND}[/{ARG}] e.g. http://frag.hosttv.com/frag/1/
H8QVGAH264/1270059632.mp4/fragment/42.

According to various embodiments, the channel name will be the same as the backend-channel name that is used as the channel portion of the SDP file. VoD uses a channel name of “vod”. The BITRATE should follow the BITRATE/RESOLUTION identifier scheme used for RTP streams. The ID is dynamically assigned. For live streams, this may be the UNIX timestamp; for DVR this will be a unique ID for the show; for VoD this will be the asset ID. The ID is optional and not included in LIVE command requests. The command and argument are used to indicate the exact command desired and any arguments. For example, to request chunk 42, this portion would be “fragment/42”.

The URL format makes the requests content delivery network (CDN) friendly because the fragments will never change after this point so two separate clients watching the same stream can be serviced using a cache. In particular, the head end architecture leverages this to avoid too many dynamic requests arriving at the Fragment Server by using an HTTP proxy at the head end to cache requests.

According to various embodiments, the fragment controller is a daemon that runs on the fragmenter and manages the fragment writer processes. A configured filter that is executed by the fragment controller can be used to generate the list of broadcasts to be recorded. This filter integrates with external components such as a guide server to determine which shows to record and which broadcast ID to use.

According to various embodiments, the client includes an application logic component and a media rendering component. The application logic component presents the user interface (UI) for the user, communicates to the front-end server to get shows that are available for the user, and authenticates the content. As part of this process, the server returns URLs to media assets that are passed to the media rendering component.

In particular embodiments, the client relies on the fact that each fragment in a fragmented MP4 file has a sequence number. Using this knowledge and a well-defined URL structure for communicating with the server, the client requests fragments individually as if it was reading separate files from the server simply by requesting URLs for files associated with increasing sequence numbers. In some embodiments, the client can request files corresponding to higher or lower hit rate streams depending on device and network resources.

Since each file contains the information needed to create the URL for the next file, no special playlist files are needed, and all actions (startup, channel change, seeking) can be performed with a single HTTP request. After each fragment is downloaded, the client assesses, among other things, the size of the fragment and the time needed to download, it in order to determine if downshifting is needed or if there is enough bandwidth available to request a higher bit rate.

Because each request to the server looks like a request to a separate file, the response to requests can be cached in any HTTP Proxy, or be distributed over any HTTP based content delivery network CDN.

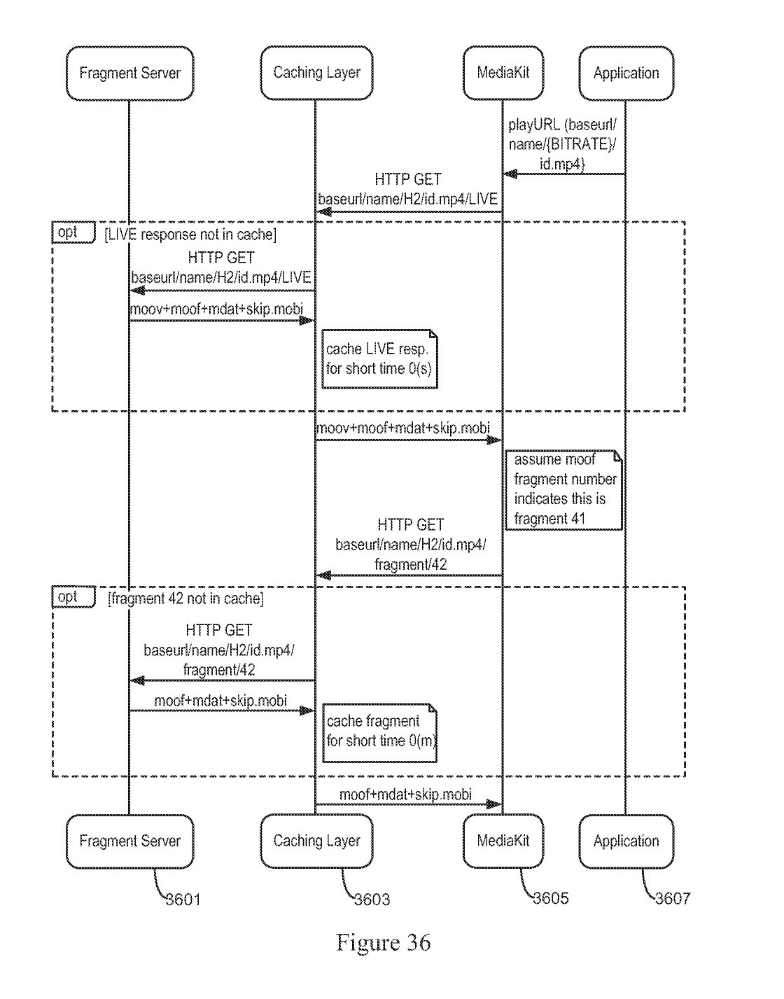

FIG. 36 illustrates an interaction for a client receiving a media stream such as a live stream. The client starts playback when fragment 41 plays out from the server. The client uses the fragment number so that it can request the appropriate subsequent file fragment. An application such as a player application 3607 sends a request to mediakit 3605. The request may include a base address and bit rate. The mediakit 3605 sends an HTTP get request to caching layer 3603. According to various embodiments, the live response is not in cache, and the caching layer 3603 forwards the HTTP get request to a fragment server 3601. The fragment server 3601 performs processing and sends the appropriate fragment to the caching layer 3603 which forwards to the data to mediakit 3605.

The fragment may be cached for a short period of time at caching layer 3603. The mediakit 3605 identifies the fragment number and determines whether resources are sufficient to play the fragment. In some examples, resources such as processing or bandwidth resources are insufficient. The fragment may not have been received quickly enough, or the device may be having trouble decoding the fragment with sufficient speed. Consequently, the mediakit 3605 may request a next fragment having a different data rate. In some instances, the mediakit 3605 may request a next fragment having a higher data rate. According to various embodiments, the fragment server 3601 maintains fragments for different quality of service streams with timing synchronization information to allow for timing accurate playback.

The mediakit 3605 requests a next fragment using information from the received fragment. According to various embodiments, the next fragment for the media stream may be maintained on a different server, may have a different bit rate, or may require different authorization. Caching layer 3603 determines that the next fragment is not in cache and forwards the request to fragment server 3601. The fragment server 3601 sends the fragment to caching layer 3603 and the fragment is cached for a short period of time. The fragment is then sent to mediakit 3605.

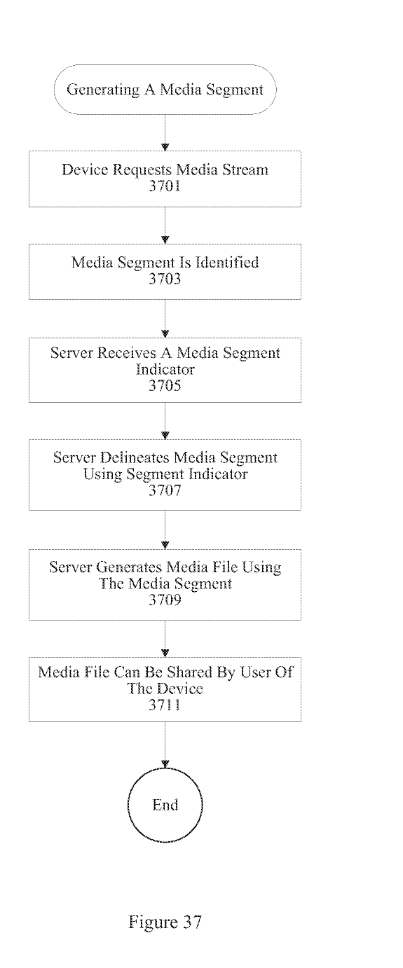

FIG. 37 illustrates a particular example of a technique for generating a media segment. According to various embodiments, a media stream is requested by a device at 3701. The media stream may be a live stream, media clip, media file, etc. The request for the media stream may be an HTTP GET request with a baseurl, bit rate, and file name. At 3703, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 3705, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 3707. The media stream may only be available in a channel buffer. At 3709, the server generates a media file using the media segment maintained in cache. The media file can then be shared by a user of the device at 3711. In some examples, the media file itself is shared while in other examples, a link to the media file is shared.

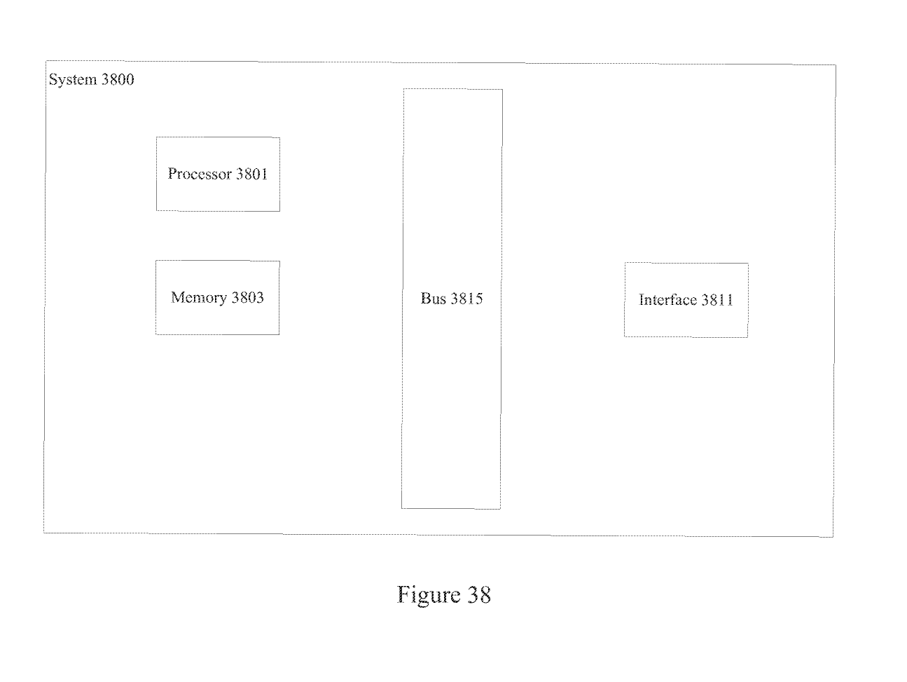

FIG. 38 illustrates one example of a server. According to particular embodiments, a system 3800 suitable for implementing particular embodiments of the present invention includes a processor 3801, a memory 3803, an interface 3811, and a bus 3815 (e.g., a PCI bus or other interconnection fabric) and operates as a streaming server. When acting under the control of appropriate software or firmware, the processor 3801 is responsible for modifying and transmitting live media data to a client. Various specially configured devices can also be used in place of a processor 3801 or in addition to processor 3801. The interface 3811 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 3800 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A computing device comprising:
communications interface operable to receive content management information from a remote server;
a memory module operable to store the received content management information;
a processor operable to process the received content management information to provide a content management interface, the content management interface including a plurality of media content categories, each of the media content categories including a plurality of media content items available for presentation at the computing device, each of the media content items being retrievable from a respective media content source, at least two of the media content items being retrievable from different media content sources; and
a display screen operable to display the content management interface.

2. The computing device recited in claim 1, wherein selected ones of the media content items are capable of being viewed on a plurality of computing devices.

3. The computing device recited in claim 1, wherein the processor is further operable to:
receive a selection of a media content item for presentation,
retrieve the media content item from the respective media content source, and
provide the retrieved media content item for presentation on the display screen.

4. The computing device recited in claim 1, wherein at least one of the media content sources is a media content service provider in communication with the computing device via a network.

5. The computing device recited in claim 1, wherein the computing device is operable to transmit an instruction to update a connected content management interface displayed at a remote computing device, the connected content management interface displaying information related to the plurality of media content categories.

6. The computing device recited in claim 1, wherein the computing device is operable to receive user input designating a device at which to present a media content item.

7. The computing device recited in claim 1, wherein each media content item is a video stream capable of being accessed via a network.

8. The computing device recited in claim 1, wherein each of the computing device and the connected computing device is a device selected from the group consisting of: a tablet computer, a laptop computer, a desktop computer, a mobile phone, and a television.

9. The computing device recited in claim 1, wherein the display screen is a touch screen display capable of receiving user input.

10. A method comprising:
receiving content management information from a remote server;
storing the received content management information on a storage medium;
processing the received content management information to provide a content management interface, the content management interface including a plurality of media content categories, each of the media content categories including a plurality of media content items available for presentation at the computing device, each of the media content items being retrievable from a respective media content source, at least two of the media content items being retrievable from different media content sources; and
displaying the content management interface on a display screen.

11. The method recited in claim 10, wherein selected ones of the media content items are capable of being viewed on a plurality of computing devices.

12. The method recited in claim 10, the method further comprising:
receiving a selection of a media content item for presentation,
retrieving the media content item from the respective media content source, and
providing the retrieved media content item for presentation on the display screen.

13. The method recited in claim 10, wherein at least one of the media content sources is a media content service provider in communication with the computing device via a network.

14. The method recited in claim 10, wherein the computing device is operable to transmit an instruction to update a connected content management interface displayed at a remote computing device, the connected content management interface displaying information related to the plurality of media content categories.

15. The method recited in claim 10, wherein the computing device is operable to receive user input designating a device at which to present a media content item.

16. The method recited in claim 10, wherein each media content item is a video stream capable of being accessed via a network.

17. One or more computer readable media having instructions stored thereon for performing a method, the method comprising:
receiving content management information from a remote server;
storing the received content management information on a storage medium;
processing the received content management information to provide a content management interface, the content management interface including a plurality of media content categories, each of the media content categories including a plurality of media content items available for presentation at the computing device, each of the media content items being retrievable from a respective media content source, at least two of the media content items being retrievable from different media content sources; and
displaying the content management interface on a display screen.

18. The one or more computer readable media recited in claim 17, wherein selected ones of the media content items are capable of being viewed on a plurality of computing devices.

19. The one or more computer readable media recited in claim 17, the method further comprising:
receiving a selection of a media content item for presentation,
retrieving the media content item from the respective media content source, and
providing the retrieved media content item for presentation on the display screen.

20. The one or more computer readable media recited in claim 17, wherein at least one of the media content sources is a media content service provider in communication with the computing device via a network.
